(19) United States
(12) Patent Application Publication
(10) Pub. No.: US 2012/0320582 A1
(43) Pub. Date: Dec. 20, 2012

(54) LAMP COMPRISING AT LEAST ONE LIGHT SOURCE AND AN ELECTRONIC OPERATING DEVICE

(75) Inventors: Achim Hilscher, Friedberg (DE); Andreas Hollstein, Karlskron (DE); Armin Konrad, Grossaitingen (DE); Thomas Noll, Kipfenberg (DE); Juergen Reichardt, Schwabmuenchen (DE); Ulrich Roll, Kissing (DE); Josef Schlecht, Poettmes (DE)

(73) Assignee: OSRAM AG, Muenchen (DE)

(21) Appl. No.: 13/580,161

(22) PCT Filed: Feb. 2, 2011
(86) PCT No.: PCT/EP11/51432

§ 371 Date: Aug. 21, 2012

(30) Foreign Application Priority Data
Feb. 26, 2010 (DE) 10 2010 002 387.6

(51) Int. Cl. F21V 21/00; F21V 21/14; F21V 11/00; F21V 7/00

(52) U.S. Cl. 362/235; 362/249.01; 362/249.02; 362/249.07; 362/249.1

(57) ABSTRACT

A lamp in accordance with various embodiments may include at least one light source; and an electronic operating device; wherein at least some electronic components of the operating device are arranged laterally with respect to the light source.

### TECHNICAL FIELD

The invention relates to a lamp comprising at least one light source and an electronic operating device.

### PRIOR ART

In the flat lamps known from the prior art a base GX53 developed specially for these applications is used. Lamps including light-emitting diodes as light sources have also established themselves on the market, in which lamps the light-emitting diode (LED) module is designed as a component of the light. This is connected to the electronic driver of the light-emitting diodes without the use of a base-holder system and is connected in a heat-conducting manner to the light fixture, which then serves as a heat sink, for the purpose of dissipating the heat produced in the light-emitting diode chip.

Furthermore, a lamp holder is required in the case of lamps with a base-holder system. As a rule different codings of the base-holder system are also required to be able to prevent the insertion of unsuitable lamps into the holder. Furthermore, the lamps are designed so as to be larger in this regard and complex installation in relation to the cables, the wiring thereof and the fixing of the lamp as well as the light to the holder are required. Furthermore, symmetrical designs of a light are not achievable as a rule. Last but not least, increased material expenditure is required and only a limited luminous efficacy is ensured.

The designation of a flat lamp is taken to mean a lamp which is designed with a flat geometry. In particular the flat lamp should be taken to mean that the overall height of the light source is smaller, and in particular substantially smaller, than the width and the depth of the light source. The designation flat lamp is therefore to be taken to mean lamps in which one or more light source(s) are arranged in one plane, but also those lamps in which a discharge lamp is taken as a basis and the discharge vessel extends in one plane or, by way of example, may also be slightly conical in design. However, even with a conical shape the dimensioning should be such that the height of the cone is smaller than the radial dimensions.

Conventional flat lamps are problematical owing to their design and construction in that the electronic operating device and other components may become hot and can consequently fail and therefore limit the longevity of these lamps. Furthermore, the luminous efficacy is limited as a result of this design. A symmetrical construction of the lamp and light is frequently not possible, moreover. This results in losses in light emission.

### PRESENTATION OF THE INVENTION

It is the object of the present invention to create a lamp, in particular a flat lamp, with which a more flat design and a functional improvement may be achieved.

This object is achieved by a lamp which has the features as claimed in claim 1.

An inventive lamp or a lamp module includes at least one light source and one electronic operating device. Electronic components of the electronic operating device are arranged laterally with respect to the light source.

In particular, electronic components of the electronic operating device are arranged laterally with respect to the light source in a first housing part constructed circumferentially around the light source. Such a design reduces the flat construction once again since the components are not arranged more or less behind the light source but laterally with respect thereto and furthermore are in particular also still arranged in the circumferential direction around the light source. Last but not least more variable employability and more versatile light emission can be attained by way of an embodiment of this kind. Thermal problems during operation of the lamp may likewise be reduced and luminous efficacy increased.

The electronic operating device and the light source are preferably arranged in a common housing. Such an embodiment can reduce the number of components and the mechanical stability of the lamp is improved. Separate housings no longer have to be constructed, whereby material costs and production costs can also be saved. It may be provided that the housing is a single housing part. It may also be provided that the housing is constructed from a plurality of housing parts.

The light source and the electronic components of the operating device are preferably arranged in one plane. This is a particularly advantageous embodiment with regard to the reduction in overall height and the flat design.

The electronic components in the circumferential direction of the light source are preferably arranged in the first housing part in at least one annular section around the light source. A more variable and more uniform distribution of the components is attained by way of such an embodiment. A greater distance setting may be ensured between the components, moreover, so thermal effects may also be reduced in this regard.

In a further embodiment it is provided that at least some electronic components of the operating device are arranged laterally with respect to the light source and only in certain regions below the light source so as to overlap the light source. With this design, when the lamp is viewed from above or below, the components are arranged so as to slightly overlap the light source and, furthermore, extend laterally beyond the dimensions of the light source. This is particularly advantageous in the case of housings which are small to one side since the operating device can consequently also be arranged so as to minimize installation space without great shadowing of the light from the light source occurring.

A design in which the electronic components are arranged in a sickle shape is particularly advantageous in this connection. This allows a particularly suitable design with regard to the advantages stated above.

A partition is preferably arranged in the housing between the electronic components and the light source. This embodiment means that firstly the thermal influencing of the components during operation of the lamp owing to the heat radiation of the light source can be considerably reduced again. Furthermore, undesired light output in a direction laterally with respect to the components of the operating device can be avoided. It is precisely if this partition is designed at least partially as a reflector on its side that faces the light source that the targeted light reflection and targeted emission of light in desired directions can be improved. If the lamp includes two housing parts, with the operating device being arranged in one housing part and the light source being arranged in the other housing part, the partition can be arranged at the transition of the housing parts. If there is only one housing part, the partition can be arranged between the light source and the components of the operating device so as to be substantially parallel to the light source if the light source includes by way of example a wound discharge vessel extending substantially in one plane.

It may be provided that the lamp includes electrical contacts at its outer circumferential side and these are provided for bringing the lamp into contact with electrical contacts of a power supply or a direct voltage supply. It may be provided that the lamp includes a base on which the contact pins are arranged such that they extend laterally outwards and can be connected to contacts of a lamp holder of a light. The base can be arranged directly on the housing, in particular integrated.

It is therefore preferably provided that the first housing part, in which the electronic components are formed, and which preferably annularly surrounds the light source, simultaneously also includes the base. The first housing part therefore more or less surrounds a second housing part in which the light source is arranged.

When viewed from the front the lamp is preferably circular in design, so in particular it presents a flat disk. The first housing part is therefore a ring.

In addition to an embodiment of the lamp with an explicit base, which can be inserted in a lamp holder of a light, it may also be provided that the lamp is designed so as to be more or less base-less and the light source is arranged in a housing on which electrical contacts are formed for more or less lamp holder-less contacting with mains cables or a direct voltage. Such a compact embodiment of the lamp without a physical base-holder system provides for larger free spaces for the arrangement of the components. In particular direct contact between the electrical contacts of the lamp and the mains cables or direct voltage supply without an interconnected coupling part, such as connecting wires or the like, is provided.

With a lamp of this kind designed without a base the electrical contacts can be designed as flat electrical contact pads or the like. In addition to their spatial embodiment on a side wall, in particular a circumferential surface of the first housing part, the electrical contacts can also be formed on the back of the first and/or second housing part(s). The lamp can therefore be contacted by mains cables on both the side and back. This ensures more flexible use and employability under a wide variety of different conditions.

The height of the lamp is preferably greater than 20 mm, in particular between 10 mm and 20 mm.

It may be provided that the first housing part, in which electronic components of the operating device are arranged, is higher than the second housing part, in which the light source is arranged. It is preferably provided in this regard that the first housing part is then a maximum of 60% higher, in particular 55% higher, than the second housing part. In a preferred embodiment it may be provided that the height of the first housing part is 18 mm and the height of the second housing part is 12 mm. These are merely exemplary embodiments of a lamp in which the first housing part is higher than the second housing part. It is preferably provided in an embodiment in this regard that the electrical contacts are formed on the side wall of the first housing part. It may also be provided that the first housing part and the second housing part are designed with the same height. A more or less symmetrical hollow cylinder-shaped embodiment is then provided in this regard, with the same height over the entire radius.

It may also be provided that in the case of a further design the first housing part is lower than the second housing part. It is precisely if the lamp is a discharge lamp, and the discharge vessel of the light source does not extend in one plane but over a certain height, which is substantially smaller than the width and depth, that a slightly higher second housing part is required. A discharge vessel is cited here by way of example which includes a conically wound discharge tube.

A ratio between the height of the first housing part with the electronic components and a second housing part, in which the at least one light source is arranged, is preferably between 0.8 and 2, in particular between 1.0 and 1.5.

A ratio of an external diameter of the first housing part to an external diameter of the second housing part, in which the at least one light source is arranged, is preferably between 1.2 and 2, in particular between 1.4 and 1.7, preferably 1.5. Such dimensioning leaves as much radial space as possible for the light source, so the luminous efficacy and the light emission, and therefore the LOR (Light Output Ratio), is significantly improved. Furthermore, this dimensioning means that a surrounding ring can be created according to the first housing part which owing to its circumferential length can likewise incorporate a sufficient number of electronic components of the housing part and can also be formed so as to be relatively thin radially in this regard.

Relatively small values for the ratio of the external diameter of the first and second housing parts may be achieved if the number of components, which are to be accommodated in the first housing part, can be reduced. This can be achieved for example by removing parts of the electronic devices, which are required for example for implementing the harmonic requirements and rectifying, into a third housing part which provides the electrical contacts of the lamp for example with 60 V direct voltage.

In an advantageous embodiment it may also be provided that the electronic operating device has a first operating device part whose electronic components are arranged in a first housing which constitutes the first housing part. The operating device includes a second operating device part, moreover, whose electronic components are arranged in a further housing which according to the above numbering is the third housing. The third housing is arranged so as to be spaced apart from the lamp and also from the first operating device part. Such a division of the electronic operating device into two separate units, which are also spaced apart from each other in terms of location, means a quite specific division of components can occur.

As a result of this the compatibility of a light, which is designed for a certain mains voltage, with a lamp can be improved with regard to the use and employability of different lamps, consequently enabling the more flexible use of the light.

It is preferably provided that the two operating device parts are electrically connected by at least one low-voltage cable.

It is preferably provided in this connection that this low-voltage cable can therefore also be constructed without surrounding insulation and yet still satisfies the corresponding safety requirements as a result. It is also possible to touch this low-voltage cable as a result, without harm occurring to a person touching the cable.

The output voltage at the second operating device part, and therefore also the voltage transmitted via the low-voltage cable, is preferably less than or equal to 60 V. This is a particularly advantageous design with regard to the safety requirements when a person touches the cable.

The second operating device part preferably includes electronic components for connecting and disconnecting the light with the lamp from a power grid, and includes, moreover, components for carrying out a power factor adjustment as well.

A suspension device is preferably formed on the third housing for suspending the light from a ceiling of a room. In addition to the electronic functionality, the third housing therefore also includes an additional functionality for fixing the light. It may also be provided that additional functional components, such as a fan, an air freshener, a noise source which is coupled in particular to a doorbell, a signal receiver, a smoke detector, a weather station or the like, are arranged in or on the third housing. In the case of a signal receiver it may be provided that this receives control signals from a remote control which can be used either for light control (brightness, color) and/or for programming and operating the additional electronic or non-electronic components.

The first operating device part is preferably arranged on the lamp, in particular integrated on the lamp. An inseparable connection, which therefore cannot be released without destruction, is therefore preferably formed between the first operating device part and the lamp. By removing certain components of the first operating device part—such as for radio interference suppression or harmonics reduction—an embodiment of the first operating device part which is minimized in relation to installation space and is even more compact can be enabled. It is precisely in this regard therefore that by dividing an electronic operating device into two operating device parts the possibility is created of functionally individually adapting the first operating device part to the lamp which is directly connected thereto. The second operating device part can therefore be designed so as to be more or less superior with regard to its functionality and for a compatible mode of operation to be designed with a large number of different types of lamp, wherein the compatibility with regard to signal transfer to the first operating device part is also ensured in this respect. The multiple compatibility of a wide variety of embodiments is ensured as a result, whereby the more flexible use and different design options of the light with the lamp are increased again.

The first operating device part preferably includes electronic components for decoding control signals received by the second operating device part. The control signals can in particular include signals for dimming and/or changing the color of the light emitted by the lamp. The first operating device part is preferably a dimmable ballast therefore.

It may also be provided that a lamp includes a plurality of light sources, each with an operating voltage of 12 V, which are connected in series. A low voltage principle is consequently achieved in which a plurality of lamps or light sources of a lamp are arranged in a series connection, wherein the number of lamps or light sources is selected such that a direct voltage of 60 V is not exceeded.

The external diameter of the first housing part is preferably between 80 mm and 220 mm, in particular between 100 mm and 200 mm and particularly preferably 120 mm.

The light source, and in particular the second housing part, preferably extends over a width of 200 mm at most, in particular more than 150 mm and particularly preferably between 60 mm and 100 mm, wherein 80 mm is a preferred value which is to be emphasized.

By arranging the electronic components in the circumferential direction around the light source it is possible to achieve a significantly more thermally relaxed design due to extensive thermal decoupling of the lamp from the electronic operating device. No lamp-operating device interface is required and very high lumen packets and a high efficiency can be attained. Bidirectional emission with particularly high LOR may also be attained. Rotationally symmetrical emission can be achieved, moreover. It is precisely with embodiments of the lamp with a base-holder system that this may also be formed without coding keys.

It may be provided that the lamp includes at least two, in particular three, preferably four, electrical contacts. These can be designed as flat pads or as contact pins. It may be provided that two electrical contacts, in particular contact pins, are formed for connection to a power supply or a direct voltage supply, a third contact is designed for connection to ground potential and a fourth contact is designed as a control cable via which the lamp receives information on adjusting the brightness and/or the coloring of the light generated by the lamp.

It may be provided that the contacts are directly arranged on the housing in this regard if the lamp is designed without a base.

If the lamp does include a base, the electrical contacts are preferably formed on this base. If the lamp includes a base, and can be used in a light with a lamp holder, then it is preferably provided that all elements of the base are arranged in a segment of a circle with a diameter which is between 2 mm and 40 mm greater than the external diameter of the base or the first housing part on which the base is arranged.

A flat, plate-like conceptual design is preferably provided with regard to the embodiment of the light with at least one lamp. The lamp support can consist of a single plate which includes recesses into which the lamp can be inserted accordingly. An insertion option similar to a bayonet socket can be provided here by way of example. For this purpose it can be provided that, in addition to the electrical contacts, the lamp also includes at least one locking element. This is preferably arranged so as to be spaced apart from the electrical contacts on the circumferential side. The lamp is then firstly inserted into the plate-like light, which includes the lamp support in the form of the plate, and the position can then be adjusted by rotation in the inserted position about the longitudinal axis of the lamp. Contacting of electrical cables, which are laid in this plate-like lamp support, by way of electrical contacts is then provided in this position.

Indentations are preferably formed in this plate-like lamp support at the edge of the recess, into which indentations the contacts are led during the rotary movement in order to attain the end position of the lamp in the lamp support. The indentation is formed as a cavity in the plate in this respect.

It may also be provided that the lamp support is formed from two separate plates which are joined together. The locking element and the electrical contacts can be arranged in different planes with regard to the height design of the lamp and it may be provided that an indentation is formed in a recess for the locking element in the first plate and an indentation is formed on a recess for the electrical contacts in the second plate. With an embodiment of this kind the locking element and the contacts can then be arranged and guided more or less in different height levels in the lamp support. Fixing of the lamp in the lamp support and electrical contacting can be reliably and permanently ensured as a result.

It may also be provided that the at least two electrical contacts are arranged at opposing sides of the lamp and lie more or less on a straight line through the center point of the lamp.

It may also be provided, moreover, that two contacts are arranged on one side and, viewed in the vertical direction, are positioned directly above each other.

An electrical contact can also be designed as a twin contact wherein an inner pin part is formed by way of example for contacting with mains voltage. Electrical insulation is then attached around the outside of this first pin and around it on the outside is formed a second contact, which is designed by way of example for controlling the coloring or for contacting ground potential. With a single contact pin two separate contacts are therefore provided which are electrically insulated from one another by a hollow cylindrical insulation sleeve.

In one embodiment it may be provided that a module diameter is 120 mm by way of example. A diameter of a light opening can be 121 mm, moreover, it being possible for the spacing between two mains cables in the lamp support preferably to be 123.5 mm. A diameter of a movement zone in the lamp support, in which the contact pins and/or a locking element of the lamp then extend and project beyond the outside of the module diameter, is preferably 126 mm, moreover. A diameter spacing between two opposing contact supports is preferably 130 mm, a spring deflection of these spring contacts preferably being 1.2 mm in this regard.

It may be provided that the light is designed for receiving a plurality of lamps. The lamps can all be of the same lamp type and be by way of example flat lamps which are designed as discharge lamps. They can have different or the same diameters.

It is particularly advantageously provided that the light is designed for receiving at least two different lamp types. It may be provided here by way of example that a discharge lamp, which is designed in the form of a flat lamp, can be used as a first type of lamp. An additional lamp based on light-emitting diode technology may also be used. Organic light-emitting diodes, what are known as OLEDs, may also be provided in this regard. It is also possible, moreover, for lamps based on halogen lamps to be used. Such variability and multiple employability of different types of lamp, i.e. lamps which are based on different technologies, significantly increase the range of applications of the light.

It may be provided that the light with its plate-like lamp support and its correspondingly flat lamps is likewise designed as a flat plate in the form of a disk or the like. The different lamps or the plurality of lamps can be inserted in the light or lamp support of the light in a wide variety of geometry distributions. They can be arranged in different annular segments around a center point of the lamp support of the light. They can, moreover, be arranged with a different angular offset from each other, viewed with respect to the circumferential direction, in this regard. A wide variety of possible applications and insertion options result therefore, so a large number of lighting possibilities, lighting patterns and the like may be produced.

With regard to the modular design, the diameter projection between the module diameter and the diameter of the movement zone for the contact pins and the at least one locking element is preferably in a range between 2 mm and 10 mm, more preferably between 4 mm and 8 mm, and in particular 6 mm.

In a preferred design at least two electrical contacts are arranged on the cylindrical circumferential surface of the lamp in 180° symmetry. This results in particular in the possibility of rotating the lamp about the contact axis which runs through the center point of the lamp.

It is precisely if more than two contacts are provided that further contacts can be implemented by way of contact pairs, which are arranged one above the other or are formed by twin contacts which nest in each other.

In the case of two separate contacts arranged one above the other, the spacing is preferably between 2 mm and 8 mm, in particular between 3 mm and 4 mm.

The electrical contacts can be formed as spring contacts in an advantageous design.

The length of these electrical contacts when viewed in the radial direction is in particular between 2 mm and 8 mm, preferably between 4 mm and 5 mm.

In the outer region, and therefore parallel to the circumferential surface of the first housing part, the contacts are designed so as to be flat in particular. The dimensions lie in particular in a range between 0.5 mm and 2.0 mm, preferably at 1.5 mm. They are coordinated in particular with the size of the opposing element to be contacted, on which they can resiliently rest in particular.

With regard to this contacting, an electrical cable running parallel to the light axis is preferably formed in the lamp support and is contacted by a contact.

In the region around the electrical contacts the lamp support preferably has a rotationally symmetrical undercut zone. This is dimensioned in particular such that firstly the electrical cables are arranged so as to be safe to touch and, furthermore, the contacts can flex in this region.

The lamp includes at least one locking element which is resiliently arranged in particular on the cylindrical circumference of the lamp housing. The direction of spring is preferably in the radial direction of the lamp. Slots can be introduced by way of example above and below the locking element in this regard.

A locking element preferably has the form of a hemisphere with a preferred height greater than 1 mm, in particular between 1 mm and 5 mm, preferably 3 mm.

A locking element is preferably arranged at an angle between 30° and 60° with respect to an electrical contact element, and is preferably positioned at an angle of 45° thereto.

The electrical contacts and the at least one locking element are preferably more or less threaded through the light-side opening via corresponding feeding slots when the lamp is inserted into the lamp support.

Following this threading the lamp preferably rests on the locking element at the lower side of the undercut zone, thus avoiding mechanical loading of the electrical contacts.

The electrical contacts and the at least one locking element can preferably be freely rotated in this undercut zone about the longitudinal axis of the lamp up to the region which includes an inwardly directed molded part for each locking element and into which the locking element latches when a certain expenditure of force is exceeded.

The angular spacing between the electrical contacts and a locking element is in particular a mutually coordinated position such that, following locking, the contacts are perpendicular to the, in particular linearly guided, electrical cables.

The end position of the lamp in the lamp support is preferably attained following insertion in the direction of the lamp longitudinal axis and a subsequent rotation about 45°.

In particular it is provided that the lamp support, in particular the plate-like lamp support at the end position of the locking element in the lamp support, is designed so as to be open at the top and/or bottom. This makes it possible to snap the locking element out of the lamp support when there is an option provided for rotating or tilting the lamp relative to the lamp support.

Lamp holder elements are worked into the plate-like lamp support.

In the region of the lamp holder the light preferably includes an insert as an injection molded part which encompasses all mechanical lamp holder elements, in particular even the power supply lines.

In a particularly advantageous design the lamp can be swiveled or rotated about at least one axis of rotation, wherein this axis of rotation runs through at least two contacts and the center point of the lamp. It is precisely with reflector applications that this is particularly advantageous since different positions of the lamp can be produced and therewith different lighting positions and different illumination levels can be achieved. This rotation is particularly advantageous if the lamp module is designed as an LED module since in this case the strength of the LED to emit directed light becomes important.

Furthermore, in the case of a round lamp or a disk-like lamp it is possible to contact lamps from adjacent regions on the same conductor in the light.

In the case of rotation of the lamp and the corresponding embodiment of the contacts it may also be provided that contacting of the lamp-side pin with the light-side wire is made solely via bending moments which result with an appropriate embodiment of the dimensions (pin diameter and spacing of the light-side wires, and the materials). A virtual distribution of the contact pin between the two cables or wires in the light is therefore made possible in this regard.

It may be provided that outer pins are provided for connection to the mains cables and provide shock-hazard protection, an inner pin for contacting ground potential and a control cable being possible in which no shock-hazard protection needs to be provided, however. This embodiment is particularly advantageous in the case of twin contacts with regard to multifunctional uses, in the rotation of the lamp and for compact embodiments.

The lamp is preferably designed as a flat cylinder, and this means that its height is smaller, in particular much smaller, than the width and depth.

With regard to the production of a light of this kind with at least one flat lamp it is provided that a plate-like lamp support is formed in which a flat lamp can be inserted. The light can consequently be produced with a minimal number of components, wherein, in addition to a lamp, the lamp support is produced solely from a plate or two combined plates as the essential components.

With regard to known embodiments it is therefore also achieved by way of such a simple flat embodiment that there is no limitation in the choice of lamp as a result of the base-holder system provided in the light. A control cable for selective control of lamps or lamp groups can also be enabled, moreover, for example with the aid of a light management system, and this is not the case in conventional systems. When using halogen light sources as the lamp in the light the interposing of a very cost-intensive light head, such as in rail systems, is no longer necessary, moreover. The easy and installation space-minimized accommodation of an electronic operating device in the case of linear luminaires can be significantly improved compared with the prior art, moreover.

This kind of embodiment of a light and its production means a use of lamps across different technologies, which include halogen lamps with an integrated operating device, low-pressure discharge lamps with or without an integrated operating device, light-emitting diode modules, modules with high-pressure discharge lamps, and OLEDs with integrated driver modules, are provided.

It is also possible to easily connect a plurality of such plate-like, individual lights, moreover, so lighting systems which can be designed in many ways can be produced from a plurality of lights as a result. By way of example lights can be connected by simple interlocking and contacting of the respectively integrated electrical cables. A flexible solution to lighting tasks can be simply, more precisely and more comprehensively enabled. It is precisely with the use of low-pressure discharge lamps that a high efficiency of more than 90 mW can be attained. The light output ratio can be significantly improved in the case of bidirectional emission, moreover. Last but not least high output and luminous flux packets up to 30 klm/m can also be achieved, so suitability as what is known as a high bay light is satisfied in this regard. It can also enable the use of reflectors and air cleaning conceptual designs.

The lamp support is substantially constructed from one or two flat plate(s). These plates can have any geometry. Rectangular or circular or oval plate-like embodiments are preferably provided. In particular the plates are formed from an electrically non-conductive material, such as plastic, wood or glass or from a PMMA material, and this is also called Plexiglas. A plate of this kind is preferably designed as a profiled plate which in particular includes reinforcing struts in appropriate regions. Indentations in the form of continuous holes with preferably standardized diameters are formed in these plates to receive different lamp modules. A lamp module can be designed in accordance with a lamp, as described in detail and in various forms previously. The recesses in the plates have notches and milled grooves in the form of edge indentations which, together with the corresponding complementary elements of the lamp, form a base-holder system.

Insets made of plastic, which as injection molded parts contain all mechanical lamp holder elements, may also be used in place of these notches and milled grooves.

Electrical cables are laid in the lighting module or a light preferably at a spacing from the center points of the recesses for the lamps and these are connected to mains voltage, a direct voltage such as 60 V DC and protective ground and the control cable. In particular these cables are arranged behind a milled groove and are therefore arranged so they cannot be touched and are thus contact safe.

The lamp modules or the lamps can preferably be connected to the electrical cables by way of example via spring contacts or twin contacts. It may be provided that an electrical cable laid in the lamp support has a rectangular cross-section, so contacting by an electrical contact element of the lamp is improved and is of a safer design. A contact element then preferably rests flat on this specific cable cross-section.

It may be provided that a lamp includes further elements which can also be formed as a cover disk, a grid or a reflector and are part of the lamp. An element of this kind preferably also includes a light-directing function and is preferably fixed to the first housing part.

It is precisely if a lamp support of the light is rectangular or has a linear edge limit in some form that a particularly suitable connection to a further light module, by way of example by simple interlocking, is possible at this location. It is possible to easily achieve a construction of a light module system as a result. Corner joints, such as a 90° bend, may also be achieved in this way.

If the lamp is designed as a discharge lamp then it includes a light source which has a wound discharge vessel that is filled with gas. The discharge vessel is preferably constructed to have multiple windings. In particular the discharge vessel is detachably arranged, by way of example by way of clips or brackets. The discharge vessel is in particular spiral-shaped in design and includes a spiral dome in the center. This is preferably heat-conducting and arranged by way of example on an element, such as a reflector or a metal grid, which can simultaneously also be designed as an element for reducing glare. The element is preferably mechanically connected to the first housing part, in particular arranged on an inner side of the housing of the lamp between the discharge vessel and this inner side of the housing. This connection interface is preferably standardized, so a compatible use of different elements is possible. The formation of what are known as cold spots can be achieved by way of such heat-conducting contacting of the spiral dome with this element, which is also preferably connected to ground potential to reduce electrosmog.

A spacing between two windings of the spirally wound discharge vessel is preferably between 0.4 mm and 3.5 mm. This spacing is less than 1 mm in particular in applications with bidirectional emission of the light.

The spacing between two windings or the pitch s of the spirals (=ratio between spacing of adjacent windings and diameter of the discharge tube) of the spirally wound discharge vessel is in particular adjusted such that it is optimally adapted to the lighting task. If, for example, the lamp is designed as a downlight, then the pitch should not be too small so a reflector can deflect the light emitted backwards to the front again. The pitch s is in this case preferably 1.3<s<2, preferably 1.6 . . . 1.8. If the lamp is designed as a bidirectional up- and downlight, then the pitch s can also be smaller since in this case the size of the light source plays a more important part. Preferred values are 1.1<s<1.5, even more preferred is 1.2<s<1.3.

The winding spacing depends in particular on whether the lamp is used as a directed light source or as a bidirectional light source (up- and downlight).

A ratio between a spacing between two windings of the discharge vessel and an external diameter of the discharge vessel is advantageously between 0.03 and 0.3, in particular between 0.02 and 0.2, moreover.

The discharge vessel preferably extends in one plane.

It can in particular be provided that the discharge vessel is coated with an air-cleaning layer, by way of example with TiO₂.

It is particularly preferably provided that the lamp includes at least one second housing part in which the at least one light source is arranged, wherein at least one or more opening(s) are formed on the upper side and/or lower side of this second housing part and these allow a through-flow of air. A targeted dissipation of heat by convection can be achieved as a result which allows the efficiency in particular of lamps based on LEDs to be increased in that the junction temperature of the semiconductor chip relevant to the luminous efficacy is minimized. With lamps based on CFL the power density can be increased since the additional air flow can be used for adjustable cooling of the cold spot.

It may also be provided that the first housing part is formed on the upper side and/or lower side and/or the side wall for the through-flow of air. A heat transfer from the region in which the electronic components of the operating device are arranged can also be ensured as a result.

With regard to production of an air flow of this kind, a fan or a piezo-driven fan can be explicitly provided which is arranged in the first housing part. This can be arranged by way of example on a circuit carrier.

The exchange of air is preferably dependent on the operating parameters of the lamp and at least one element of the lamp limiting convection is designed such that the cold spot of the lamp constructed as a discharge lamp lies at an ambient temperature of between 15° C. and 30° C., in particular between 40° and 55°. The lamp therefore preferably regulates the exchange of air over the surface and the temperature gradient between above and below, which is substantially dependent on the specific area output (W/cm² lamp area) and an ambient temperature.

The lamp preferably includes an element limiting convection and which is in particular a diaphragm or a grid or a reflector. The cover already discussed above can be provided in this regard and is constructed in particular with openings on the lower side. The cover preferably includes openings on the circumference, ensuring controlled adjustable convection.

The lamp also includes in particular a reflector which can be detachably provided on the housing, in particular can be detachably provided on the upper side and/or lower side of the housing. Mounting on the first and/or the second housing part(s) can be provided in this regard. A wide range of lamp variants can be formed simply and quickly due to the detachable mounting.

A great advantage of this modular construction is (in contrast to the prior art in which the lamp is usually completely surrounded by the light) that all elements for optimizing the luminous properties (reflector, grid, convection regulator, etc.) are components of the lamp module and therefore the light can no longer exert an adverse effect.

A reflector element, hereinafter called a reflector, is preferably coated with TiO₂. As a result of an embodiment of this kind the adjustable convection allows more efficient cleaning of air compared with a version in which the TiO₂ is on the lamp surface, and this leads to a reduction in the luminous flux.

The reflector can in particular be constructed such that it is designed for light diffusing and/or photocatalysis and/or color conversion of the light. A multifunctionality can be achieved by a specifically constructed and/or coated element. In addition to component minimization a particularly flexible adjustment of the element to the respective lamp or light is consequently also possible, so a concept which is highly adapted to the situation is achieved with regard to the use of the lamp or light.

The reflector preferably includes a plate-like support which is constructed from plastic and is coated with an at least partially reflective layer.

The support is in particular constructed from at least two different plastics which have different refractive indices. A particularly suitable embodiment for generating light can be enabled in this regard which is also designed so as to be much minimized weight-wise, moreover. It is particularly advantageous provided that a first plastic is PC (polycarbonate) and a second plastic is PMMA.

The intrinsic diffusing effect can be intensified by such an embodiment of a reflector made of two different types of plastic. The support is preferably constructed from a material which lets light at least partially through, so the configuration of the element directing light is provided as a partially mirror-coated reflector with a reflection factor R.

TiO₂ is introduced as a material into the at least partially reflective layer in particular with regard to photocatalysis.

Diffusing bodies are preferably formed in the reflector for light diffusing and these are at least partially constructed as diffusing bodies made from a phosphor material of the YAG:Ce type. A phosphor of this kind called L175 is used by way of example by the applicant. Corresponding phosphors are also possible in which the element yttrium is partially or completely replaced by one of the rare earth metals.

It may be provided that the at least partially reflective layer is provided on the side of the reflector facing the lamp. A direct reflection can be achieved as a result. However, it may also be provided that this coating is applied to the side of the reflector that faces away from the lamp. With an embodiment of this kind a reflection is only made possible in accordance with transmission of the support of the reflector layer. The plastics material of the support in particular includes a corresponding transmittance T.

Depending on the embodiment and individual employability, the reflector can therefore be adjusted to the specific situation and light is either reflected almost completely or is transmitted almost completely depending on the size of the reflection factor R and the transmittance T of components or material constituents of the reflector. The reflector can therefore also be degraded into a cover disk in this respect.

The reflector and the cover disk can also be configured in such a way that they can be used as a convection limiter and practically switch off convection. Corresponding lamps, which are constructed on the basis of CFL, can consequently also be used in very cold environments, such as in cold stores.

It is precisely by adding TiO₂ in connection with UVA radiation that a photocatalytic degradation reaction of organic vapors is made possible, and this leads to the formation of CO₂, water and nitrates. This allows air cleaning, precisely in connection with the use of low-pressure discharge lamps with an integrated operating device.

The photocatalytic reaction is enabled without the generation of negative ions, moreover. If the reflector is arranged on the upper side of the lamp and the TiO₂ layer is provided on the inside of the reflector, then, owing to convection, the air always comes into contact with the reflector coated with TiO₂, moreover, and this leads to a high through-flow of air and therefore to efficient air cleaning.

The material onto which the reflective layer is applied preferably has a diffusing characteristic and has a diffusing power S. If the reflectance is equal to 0 and the transmittance almost 100% and the diffusing power equal to 1, the reflector is degraded to a diffusing plate. The diffusing power can be used to adjust glare and this can be reduced accordingly.

In the context of the invention a reflector is taken to mean a component which at least partially reflects light, wherein this is taken to mean both directed reflection according to the optical rule where incidence is equal to loss of light as well as diffusing.

The diffusing bodies are preferably made at least partially of a phosphor, wherein a phosphor is preferably provided in this regard which converts blue light, by way of example mercury lines and parts of the BAM spectrum, into longer-wave light, by way of example in the green-red spectral range with a temperature shift with respect to that of the light source. The phosphor of the YAG:CE type already mentioned above is mentioned here by way of example.

The grain structure d of the phosphor is preferably in a range between 1 μm and 50 μm.

In a preferred embodiment it is provided that the phosphor is formed as an additional layer on the at least partially reflective layer. In particular the phosphor is preferably contained in the granules of the plastic from which the plate-like support is constructed.

The transmittance of the reflector is adjusted in particular by way of the thickness of the reflector layer. An aluminum-containing material may be provided by way of example as the material for the reflector layer. If the reflectance should be R=100%, then non-transparent plastics may also be used as the materials for the support, for example ABS, PBT, PET.

Nanoparticles of the TiO₂ anatase form are preferably formed. Silver ions may also be provided to reinforce the antibacterial effect.

A grain size between 0.2 and 1 μm, preferably 0.5 μm, is preferably provided in reflector applications.

In the case of applications including a diffusing plate, layer thicknesses between 0.1 and 0.6 μm, preferably 0.2 μm, are provided.

It is precisely if the lamp, with which the reflector is operated, includes a spiral-shaped discharge vessel that these spirals tend to be widely wound and have a medium pitch. The LOR and the efficiency of the lamp are maximized as a result.

If the spiral-shaped embodiment of the discharge lamp is coated with an inhomogeneous layer thickness of phosphor then the side with a thicker layer of phosphor is directed in the direction where less light should be emitted through the lamp or on the side on which the reflector should be provided.

The discharge vessel preferably has a thicker layer of phosphor on the side facing the reflector than on the corresponding remote side. An asymmetrical layer thickness creation that occurs when the phosphor is applied to the discharge vessel can be used in a purposeful and defined manner as a result.

The reflector is preferably constructed with regard to its functionality for color conversion of light at a first color temperature into light at a second color temperature lower than the first.

A lamp with a reflector of this kind is preferably designed such that the light emitted by the light source can be divided proportionally by means of the reflector into a reflected portion and a let-through portion and the proportion ratio is freely adjustable.

With regard to the further advantageous embodiments of the inventive lamp it may also be provided that a dirt protection element or dirt trap can be provided on the upper side of the housing of the lamp. This can be detachably provided on the first or second housing part. The accumulation of dust or the like, which flows over the lamp by convection, on the surface, adjacent to the light source to which the light source is fixed (for example a ceiling), can be avoided as a result of this embodiment.

A further element is preferably arranged on the lower side of the housing. As mentioned previously, this can be a grid, reflector or a diffusing plate or a Plexiglas plate with a light-directing foil, such as a BEF (Brightness Enhancing Foil) provided thereon. These elements can also preferably be reversibly mounted and demounted and thereby increase the flexibility of the lamp module and allow a user to customize his light.

The lamp can be designed in different ways with regard to the technology of the light generation and therefore its lamp type. It can be designed as a discharge lamp (low pressure or high pressure) and include a corresponding discharge vessel with respect to the light source. Low-pressure discharge lamps with an integrated or external electronic operating device can be provided in this regard.

A further lamp type may be an LED lamp which includes at least one semiconductor component, in particular a light-emitting diode, as the light source. The light-emitting diode can be constructed by way of example as an OLED and therefore as an organic light-emitting diode.

It is precisely if the light source is a light-emitting diode that the light-emitting diode support can be thermally contacted by at least one heat sink, the heat sink being associated component-specifically with the lamp. The heat sink can be dome- or cylinder-shaped and preferably has a radial ribbed structure which is preferably open on the air intake side and can therefore bring about a chimney effect.

The support module, on which the light-emitting diodes are arranged, can be contacted directly by a cooling plate, on which the heat sink is arranged, wherein the heat sink and the support plate are constructed on different sides of the cooling plate. In the outer region the cooling plate preferably includes slots for a through-flow of air. This ensures a free airflow.

It may also be provided that the heat sink is designed with a vaulted structure and can be designed by way of example as a paraboloid or the like in this regard.

In the region of the outer heat sink assembly the housing is preferably provided with openings for the through-flow of air. It is preferably provided that a blower or a fan is integrated in the heat sink and this provides for an additional through-flow of air and for corresponding additional forced cooling.

The fan is preferably electronically controlled via a temperature sensor that measures the temperature on the printed circuit board. As a result the fan enables a very targeted generation of airflow depending on requirements, thus enabling use of the lamp even at relatively high ambient temperatures, and the efficiency of the lamp is increased.

On its side facing upwards the lamp preferably has a cover for catching particles of dirt as a consequence of the convection-driven exchange of air. This can be the dirt protection element already discussed previously.

It may also be provided that when a reflector is used, the lamp is coated on the side facing the reflector so as to be reflective on the outside, is constructed by way of example in a manner similar to a metal mirror.

With regard to the different layer thickness formation of the phosphor on the discharge vessel already mentioned previously it is preferably provided that the phosphor coating thickness varies on the side of the discharge lamp facing the reflector and lies in this respect between the ratio of the phosphor coating thickness on the reflector side and that on the opposing light exit side in the value interval between 2 and 5.

It may also be provided that on the inside, on the side facing the reflector, the discharge vessel has an additional reflector layer which preferably reflects light forwards in a spectral range visible to human beings.

The light source of the lamp is preferably reversibly detachably arranged in the lamp. This is a quite specific embodiment which is advantageous by way of example for light sources relating to halogen lamps. These may be easily changed and replaced without the electronic devices used, which usually have a significantly longer life than that of the halogen lamp, having to be exchanged as well.

The light source is therefore preferably constructed as a halogen light source in an embodiment of this kind. It may be provided that the lamp includes at least two, in particular a plurality of halogen light sources which are advantageously connected in series.

It is precisely in the embodiment of a lamp with at least one light source as a halogen light source where it is preferably provided that the lamp is designed for operation at a voltage of 0.5 times the mains voltage at most and is connected in an inner region via a lamp holder to a device which connects at least the electrical contacts of the lamp to the contacts in the outer region of the module, and these are connected to the main voltage. It is precisely with regard to the series connection of this plurality of halogen light sources that this provides an advantage since previous lights are not usually provided and configured for such a series connection.

An increase in the efficiency and/or an extension of the service life consequently results especially when using halogen light sources in a lamp due to a reduction in the operating voltage with a series connection. Furthermore, a higher energy efficiency class can usually be attained without the use of a transformer being necessary. It is precisely in connection with halogen light sources with electronic components of the operating device arranged circumferentially around the halogen light sources that a particularly effective concept is enabled. The use of halogen light sources in the middle region and wiring and electronic display devices in the outer region around these halogen light sources is ensured therefore especially in the case of halogen lamps. Failure of a halogen light source can be indicated by a corresponding indicator lamp which can be a light-emitting diode by way of example. Failure of a lamp can therefore be traced quickly and precisely and it can be replaced.

It is preferably provided that two to five, in particular four, halogen light sources are preferably connected in series. With conventional mains voltage an operating voltage of less than 60V can consequently be achieved.

It may also be provided that a lamp includes one or more halogen light sources connected in parallel with a nominal operating voltage of 12 V, and the electronic operating device, in particular of the ballast, includes a transformer.

It may also be provided that for example five 12 V halogen light sources are connected in series and the module is connected to a, for example, 60 V direct voltage which is provided by a second operating device part associated with the light. In this case the lamp module does not contain any electronic devices aside from the display elements for lamp failure.

The halogen light sources are preferably constructed as pin-base lamps.

It can in particular be provided that these halogen light sources include an IR (infrared)-reflecting coating (IRC).

The housing in the inner region of the module is preferably made at least partially from a temperature-stable material, by way of example LCP or PPR or even metal. In particular receptacles, by way of example for fixing one or more reflector(s), are provided especially in this region.

The reflectors can be adjusted in the direction of the lamp axis, so it is possible to optimize the aspect ratios, in particular if the reflectors are provided in a lamp of this kind with halogen light sources.

A reflector is adjusted in this way in particular via a screw thread at the end of the reflector.

The lamp fuse is preferably integrated in the electronic operating device, so even lamps with solid holding elements can be used in the burner without a lamp-side fuse.

The lamp fuses are electronic in particular and can be reset so it is not necessary to replace the fuse when a lamp fails.

The housing of the lamp in particular includes a printed circuit board or a circuit carrier which carries the holders for the halogen light sources, which are constructed in particular as pin-base lamps, laterally oriented contact elements, display elements for lamp failure and the associated electronic devices, an electronic cut-off device or a fuse and a transformer for operating 12V halogen light sources on mains voltage (optionally with parallel circuit). The display elements are preferably designed as glow lamps which only react if mains voltage is applied to a light source.

Furthermore, it may be provided that a symmetrization of the power consumption is provided with a series connection of a plurality of lamps.

Electrical contact pins are preferably formed on the housing of the lamp about which the lamp can be rotated in a lamp holder. Such a change in position relative to the lamp holder means the lamp can be used even more variably and flexibly. Specific local positionings and therefore completely targeted light emissions and illuminations of specific locations are possible.

These contact pins are preferably arranged perpendicularly to a lamp axis of symmetry. This ensures free rotation of the lamp about at least one axis.

It is preferably provided that the rotation of the lamp about at least two mutually perpendicular axes located in the lighting plane is enabled, wherein an axis of rotation runs through two opposing contact pins. In particular it is provided that it is possible to rotate the lamp about at least one additional third axis which is perpendicular to the two other axes already mentioned. Use of different types of lamp as reflector lamps is more attractive as a result of such multiple rotation of the lamp.

In particular it may be provided that shadowing losses, which can be produced via the light primarily in the case of flat light sources, such as flat lamps in the form of low-pressure discharge lamps, may be reduced with an extension adapter.

Advantageous designs with an integrated operating device can be enabled with pin-base lamps especially if electrical contacts are constructed as contact pins in the form of twin contacts. This is possible and particularly advantageous when using rotationally symmetrical multiple contacts and, by way of example, twin pins.

It is preferably provided that a contact pin extends with its longitudinal axis axially and in the axis of rotation and therefore ensures free rotation about this longitudinal axis.

With regard to the design of a contact pin it can be provided that at least one insulating body has a larger diameter than the contact with the largest diameter and is used for locking in the holder system in the electronic ballast. It can in particular be provided that electrical contacts are provided for the housing as insertion parts in an injection mold and are injected into this housing.

In the case of a twin contact it is preferably provided that one of the two outer pins is contacted by mains voltage, and this leads to the shock-hazard protection of the counter contact being easier to achieve on the lamp holder side.

A coding system may be provided for the contact pins, moreover, it being possible for coding to occur by way of example via the pin length and the diameter and/or via journals or recesses on the circumference of the lamp housing or the operating device housing.

It can, moreover, preferably be provided that the light source of the lamp can be rotated relative to the operating device. Especially if the specific design of the lamp is such that the operating device extends circumferentially around the light source, an additional degree of freedom and a further improvement in the lamp with regard to optimal fulfillment of the lighting task is provided due to this option of movement of the components relative to each other.

The light source can preferably be rotated about at least one axis of rotation which runs through two contact pins.

It is preferably provided that the light source and/or the operating device can be rotated relative to a light, in which the lamp is accommodated. This can ensure another additional degree of freedom of rotation and more or less three components, namely the light source, operating device and light, can therefore be moved relative to each other.

The operating device is preferably rotatable about an axis of rotation which runs through electrical contacts of the operating device to make contact with the light contacts.

In particular it is also provided that the light source and the operating device are arranged in an adapter which can be rotated relative to the light in which the lamp is accommodated. The spacing between the light and the axis of rotation can be increased by way of example by such an additional adapter thereby avoiding shadowing effects during rotation. This is particularly advantageous with flat discharge lamps.

The light source and the operating device of the lamp can preferably be moved relative to each other and relative to a lamp support and/or an adapter of a light, in which the lamp is accommodated, such that the light source can be rotated relative to said components about three axes arranged perpendicular to each other.

The adapter mentioned above is preferably constructed with a diameter which is between 0.8 and 1.2 of the lamp diameter, preferably roughly matches the lamp diameter.

The electrical cables for electrically connecting the contact pins of the lamp and light are preferably integrated in this adapter.

Electrical sliding contacts are preferably formed on a housing of the operating device. Safe and reliable electrical contacting with simultaneous multiple movement of the lamp relative to other components of a light or of components of the lamp relative to each other can be ensured quite specifically by this specific embodiment of the lamp with quite specific contacts at a quite specific location. The lamp or components of the lamp can be positioned completely individually relative to each other as a result of this embodiment, so quite specific lighting options may be established.

Sliding contacts are preferably formed on an outer side of a side wall of the housing. This enables a quite specific rotation, relative to external components, such as a lamp support of a light, into which the light is inserted, with electrical contacting that is still to be ensured at the same time, especially for the entire lamp.

It may also be provided that sliding contacts are formed on an inner outer side of a side wall of the housing. It is precisely if the lamp is constructed relatively specifically with regard to its components arrangement, and, viewed in the horizontal direction, components to be electrically contacted are arranged side by side that a quite specific movement can also be ensured between two specific components of the lamp with electrical contacting that is to be maintained at the same time.

It may also be provided that corresponding contacts are formed on the outer and inner outer sides of a side wall of the housing, so the multiple movement can be increased again and the lighting scenario options and positionings of the components relative to each other can be significantly increased again.

The flexible use and employability of the lamp can be significantly increased therefore. It can be provided that two sliding contacts are arranged one above the other viewed in the vertical direction.

It may also be provided that two sliding contacts are arranged on opposing sides of the housing on a straight line through the center point of the lamp. The alternatives or supplementary possibilities therefore demonstrate a wide variety of design options, so consequently firstly a large number of embodiments are possible with regard to the positioning of the sliding contacts, whereby a wide variety of combination options are also provided with regard to the individual shaping and embodiment of the lamp. Reliable electrical contacting as well as the possible movement of components relative to each other at the same time is ensured with all of these, however.

The operating device is preferably arranged in a first housing part and the light source in a second housing part, and the housing parts are electrically contacted by sliding contacts, a movement of the housing parts relative to each other about an axis of rotation perpendicular to the housing parts being provided via the sliding contacts. A specific embodiment is therefore provided in which the components of the lamp itself can be rotated relative to each other while reliable electrical contacting can still be maintained. It is precisely if the lamp is designed as a flat lamp and circumferentially surrounds the operating device of the light source that an embodiment can therefore be created in which the light source can be rotated about the perpendicular longitudinal axis relative to the operating device, this first housing part with the operating device surrounding the light source annularly and circumferentially.

It may also be provided that the second housing part with the light source and the first housing part with the operating device are electrically contacted by electrical contact pins, and the housing parts can be rotated relative to each other about the axis of rotation through the contact pins. With such an embodiment, sliding contacts, which are different from contact pins in the context of the application, are not contacted therefore. These different types of electrical contact also result in different rotary movements of the components of the lamp with respect to each other about different axes. Rotation of the light source relative to the operating device about an axis through the contact pins and the center point of the lamp, which constitutes an axis of rotation perpendicular to the longitudinal axis, is not enabled especially with an embodiment with sliding contacts.

By contrast, the embodiment with contact pins does ensure rotation about this axis of rotation, however.

Electrical contacting between a lamp and the adapter can be provided via sliding contacts especially with insertion of the lamp in an adapter, thus enabling rotation of the lamp relative to the adapter about a specific axis and a specific direction. It is precisely as a result of this that shadowing losses may be avoided and specific lighting scenarios established.

It may also be provided that these electrical cables are integrated in the operating device of the lamp.

Extension arms of the adapter are preferably constructed as struts and are arranged such that they do not impede or affect the rotary movement about a specific axis of rotation.

With regard to the number of struts, at least two, in particular two to four, are preferably provided.

It can in particular be provided that the electrical contact system between the lamp support and the operating device of the lamp is coded, it being possible to produce a coding by way of example via the length and/or diameter of the contact pins.

It can particularly advantageously be provided that rotary movement of the lamp occurs by way of a motor drive which can, moreover, in particular be controlled by a user by way of a remote control, by way of example.

It may also be provided that the light includes an electronic control unit with a memory in which lighting sequences can be stored. This can be programmed or set via a control plate or the remote control for example.

It may be provided that different reflector lamps are used for different lighting sequences. Thus by way of example beaming of images on a wall using one or more lamp(s) of a lighting module or a light may be provided as a first application. The implementation of a reading lamp may be provided as a second functional application, it also being possible to provide numerous additional specific applications which can be set and stored as lighting sequences. A wide variety of lighting sequences can be produced very exactly and as required especially if a lighting module is fitted with a plurality of, and optionally also different, lamps and types of lamp.

The axes of rotation and moments of inertia of the objects about the axes of rotation are preferably coordinated with each other such that torques about the axis of rotation are so low that the frictional forces between the electrical contact pins and their receiver continue to keep the lamp precisely in its position.

With an embodiment of the lamp as a low-pressure discharge lamp with an external operating device and two contact pins, which are implemented by way of example as twin contacts, pre-heating is possible.

The adapter mentioned above preferably also allows adjustment of the lamp diameter, it being possible for the lamp to include by way of example the same, a larger or a smaller diameter as a corresponding lamp without such an adapter. A practical upper limit for a corresponding diameter is provided by the grid spacing of the openings in the light.

In addition to the rotation about existing axes, the construction with an adapter allows a rotation about an additional axis oriented perpendicular thereto, moreover. This is possible in particular if the mains and control cables are arranged in the manner of a circle around the lamp.

When using an adapter the connection between the adapter and the lamp support or the lamp can also be achieved on the basis of four separate contact pins since in this case a multiple pin principle is not required at the connecting point between the adapter and lamp support or lamp because all axes of rotation are then in the adapter region.

It may be provided that the electrical cables are produced by vapor deposition or MID technology or simply by laying cables and contacts. If the operating voltage of the operating device is <60V DC then these cables do not need to be designed so as to be contact-safe.

Further features of the invention emerge from the claims, figures and description of the figures. In addition to the combination disclosed in each case, the features and combinations of features cited above in the description, as well as the features and combinations of features cited in the description of the figures can be used in other combinations or alone, without departing from the scope of the invention. This means that the individual features and combinations of features cited within the scope of the disclosure can be combined to form further exemplary embodiments which are not explicitly described if they are not ruled out with regard to the type of lamp.

### BRIEF DESCRIPTION OF THE DRAWINGS

Exemplary embodiments of the invention will be described in more detail below with reference to schematic drawings, in which:

FIG. 1 shows a schematic sectional view through an exemplary embodiment of an inventive lamp,

FIG. 2 shows a schematic sectional view through a second exemplary embodiment of an inventive lamp,

FIG. 3 shows a schematic sectional view though a third exemplary embodiment of an inventive lamp,

FIG. 4 shows a schematic sectional view through a fourth exemplary embodiment of an inventive lamp,

FIG. 5 shows a schematic sectional view through a fifth exemplary embodiment of an inventive lamp,

FIG. 6 shows a schematic sectional view through an exemplary embodiment of a heat sink, as is constructed by way of example in the design according to FIG. 5,

FIG. 7 shows a schematic sectional view through a light according to a first exemplary embodiment, in which a lamp is arranged,

FIG. 8 shows a schematic side view of the lamp of the light according to FIG. 7,

FIG. 9 shows a plan view of a further exemplary embodiment of a lamp,

FIG. 10a shows a schematic sectional view of a partial detail of a further exemplary embodiment of a light with an inserted lamp,

FIG. 10b shows a further schematic sectional view of a partial detail of a light with an inserted lamp according to FIG. 10a,

FIG. 11 shows a schematic plan view of a further exemplary embodiment of a lamp,

FIG. 12 shows a schematic plan view of part of an exemplary embodiment of a light,

FIG. 13 shows a plan view of a further exemplary embodiment of a light,

FIG. 14 shows a schematic plan view of a further exemplary embodiment of a lamp,

FIG. 15 shows a schematic sectional view of a further exemplary embodiment of an inventive lamp,

FIG. 16 shows a plan view of a lamp support of a light in a first production stage,

FIG. 17 shows a side view of the lamp support according to the first production stage,

FIG. 18 shows a plan view of the lamp support according to a second production stage,

FIG. 19 shows a side view of the lamp support in the corresponding production stage according to FIG. 18,

FIG. 20 shows a further side view of the lamp support with additional elements,

FIG. 21 shows a schematic plan view of the light in a further alternative design,

FIG. 22 shows a side view of the light according to FIG. 21,

FIG. 23 shows a further exemplary embodiment of a plan view of the lamp support of a light in a specific production stage,

FIG. 24 shows a further plan view of the lamp support according to FIG. 23 in a subsequent production stage,

FIG. 25 shows a further plan view of the light according to FIG. 23 and FIG. 24 in a further subsequent production stage,

FIG. 26 shows a side view of the light according to FIG. 25,

FIG. 27 shows a plan view of a partial detail of a light,

FIG. 28 shows a plan view of a partial detail of the light with inserted lamp,

FIG. 29 shows a plan view of a partial detail of the light with the lamp in the assembled end mounting position,

FIG. 30 shows a plan view of a design of the light,

FIG. 31 shows a plan view of a lighting system with two separate lights,

FIG. 32 shows a schematic plan view of the exemplary embodiment of the lighting system according to FIG. 31 with assembled lights,

FIG. 33 shows a sectional view through a further exemplary embodiment of an inventive lamp,

FIG. 34 shows an enlarged view of a partial detail of a reflector of the lamp in FIG. 33,

FIG. 35 shows a schematic plan view of a light with fitted lamp,

FIG. 36 shows a further exemplary embodiment of an inventive lamp in a schematic sectional view,

FIG. 37 shows a schematic sectional view through a further exemplary embodiment of an inventive lamp,

FIG. 38 shows a schematic sectional view through a partial detail of a further exemplary embodiment of an inventive lamp,

FIG. 39 shows a schematic sectional view through a partial detail of a further exemplary embodiment of an inventive lamp,

FIG. 40 shows a schematic sectional view of a partial detail of a further exemplary embodiment of an inventive lamp,

FIG. 41 shows a schematic perspective view of an exemplary embodiment of a light having a plurality of lamps of different types,

FIG. 42 shows a plan view of a further exemplary embodiment of a lamp,

FIG. 43a shows a plan view of a further exemplary embodiment of a lamp,

FIG. 43b shows a side view of the lamp according to FIG. 43a,

FIG. 43c shows a view from below of the lamp according to FIGS. 43a and 43b.

### PREFERRED EMBODIMENTS OF THE INVENTION

Identical elements or elements with the same function are provided with the same reference numerals in the figures.

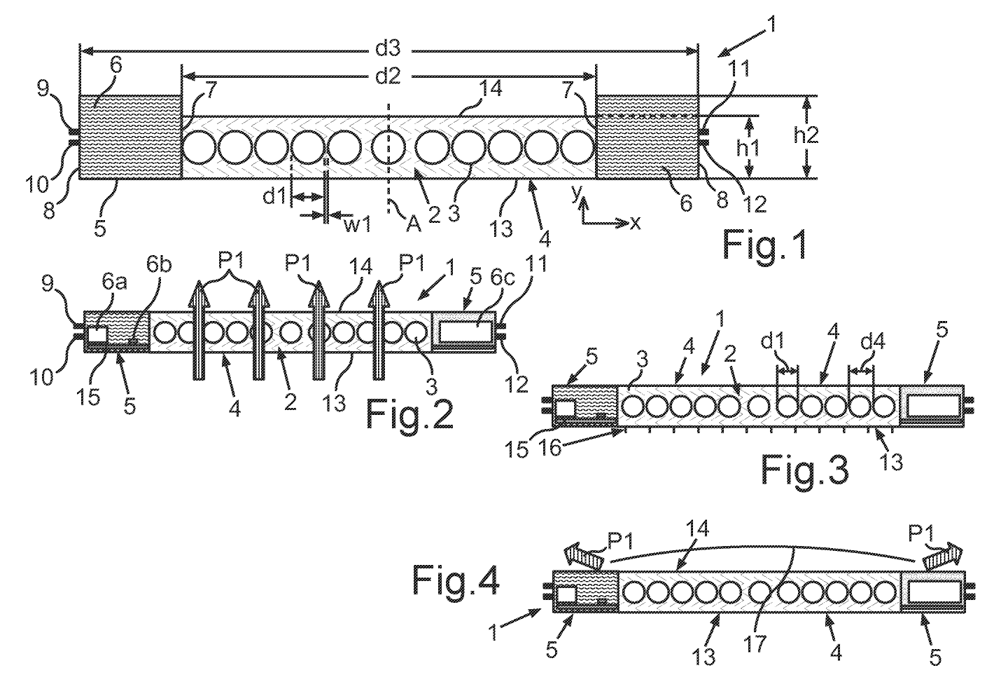

FIG. 1 shows in a schematic sectional view a first exemplary embodiment of an inventive lamp 1. In this embodiment the lamp 1 is designed as a discharge lamp. The lamp 1 includes at least one light source 2 which includes a discharge vessel 3 which is a multiply wound tube. In particular the discharge vessel 3 can be spirally wound in one plane or spirally wound and have a conical shape, wherein the height of the cone is then significantly smaller than the width and depth and therefore the radial dimension. The lamp 1 is a flat lamp and accordingly defined in this regard in particular on the basis of the embodiment of the discharge vessel 3. In the exemplary embodiment the discharge vessel 3 is arranged in a plane which extends perpendicular to the plane of the figures and includes the x axis.

The light source 2, and therefore the discharge vessel 3 as well, are arranged in a second housing part 4 which is integrally connected to a first housing part 5. An electronic operating device 6 for the lamp 1 is arranged in the first housing part 5, so the electronic components of the operating device 6 are arranged in this first housing part in this regard. The lamp 1 is designed as a flat disk or as a cylinder in the exemplary embodiment and the first housing part 5 circumferentially surrounds the second housing part 4, and therefore the discharge vessel 3 as well. With regard to the radial form the second housing part 5 is therefore designed so as to encircle the circumference of the first housing part 4 and the operating device 6 therefore circumferentially surrounds the operating device 3. The operating device 6 is therefore arranged radially further out than the discharge vessel 3 when viewed in the radial direction and therefore in the x direction. The operating device 6 is therefore circumferentially laterally arranged with respect to the discharge vessel 3 and externally in this regard.

A spacing w1 between adjacent tube windings of the discharge vessel 3 is preferably between 0.4 mm and 3.5 mm. If the lamp is to operate as a bidirectional light source, i.e. with emission in a positive and a negative y direction, the spacing w1 is preferably <1 mm. In particular a ratio between a spacing w1 between two windings and an external diameter d1 of the tube of the discharge vessel 3 is between 0.03 and 0.3, in particular between 0.02 and 0.2. It is preferably provided that this ratio is >0.05 and <0.2.

As may be seen from the illustration in FIG. 1, the second housing part 4 has a height h1 (extension in y direction) which is 12 mm. In the illustrated design it is provided that a height h2 of the second housing part 5, in which the operating device 6 is located, is greater than the height h1. In the exemplary embodiment this height h2 is preferably 18 mm.

It may also be provided that the height h2 is equal to the height h1 or is even smaller than the height h1.

It is also provided in the exemplary embodiment that a diameter d2 of the second housing part 4 is 80 mm in the exemplary embodiment, whereas an external diameter d3 of the second housing part 5, and therefore of the lamp housing as a whole, is 120 mm in the exemplary embodiment. As already mentioned the two housing parts 4 and 5 are constructed as a one-piece housing.

It is preferably provided that an encircling partition 7 is constructed between the housing parts 4 and 5, so the discharge vessel 3 is separated from the components of the operating device 6. It may also be provided that this partition 7 is absent.

As a result of such a design of a lamp 1 it can be designed so as to be particularly flat. Light emission is possible on either side in the y direction, moreover, so in the illustrated sectional view according to FIG. 1 light emission is possible upwards and downwards. In the illustrated exemplary embodiment two electrical contacts 9, 10 and 11 and 12 are constructed on a side wall 8, which simultaneously forms the encircling circumferential surface of the first housing part 5, on opposing sides respectively. The lamp 1 therefore includes four electrical contacts which can be designed in particular as contact pins, spring contacts or sliding contacts. In this connection two electrical contacts 9 to 12 are constructed for contacting the mains voltage cables, whereas a third electrical contact 9 to 12 is constructed for contacting ground potential and a fourth electrical contact 9 to 12 is constructed for transmitting control signals for adjusting the brightness and/or coloring of the light produced by the lamp 1.

The electrical contacts 9 to 12 are constructed on opposing points such that with projection onto the lamp plane they are positioned on a straight line through the center point of the circular lamp 1.

In the exemplary embodiment illustrated in FIG. 1 the lamp 1 therefore includes a base, which is constructed on the housing part 5 more or less in the region of the electrical contacts 9 to 12, so the lamp 1 can be inserted with this base embodiment into a corresponding holder of a lamp support of a light. In this regard the design of the lamp according to FIG. 1 can be introduced into a light having a holder and a base-holder system is present in this regard as a mechanical and electrical contact system.

According to the illustration in FIG. 1 the lamp 1 is therefore constructed with an integrated operating device 6, in particular an integrated ballast.

It may also be provided that the lamp 1 includes a cooling tube, for lowering the cold spot temperature, in the center, and therefore in the region of its longitudinal axis A, which also constitutes the axis of rotation.

It may be provided that the electronic components of the operating device 6 are arranged so as to be substantially uniformly distributed circumferentially around the discharge vessel 3. It may also be provided that the first housing part 5 extending completely circumferentially, and therefore annularly, around the discharge vessel 3 includes electronic components of the operating device 6 only in specific segments of a circle.

The dimensions of the diameters d2 and d3, which describe the diameters of the first and second housing parts 5 and 4 respectively, can in particular be constructed such that a ratio between the external diameter d3 and the external diameter d2 is >1.2 and <2.0, in particular >1.4 and <1.7 and preferably 1.5.

It may be provided that the lamp 1 also includes light-directing elements as well, such as one or more reflector(s), one or more diffusing plate(s) or a grid or a diaphragm limiting convection, or a light-directing foil, by way of example a BEF foil, wherein these elements are not shown in FIG. 1. These elements may preferably be located in the region of the second housing part 4 at a spacing therefrom or in direct contact therewith, on a lower side or front 13 or an upper side or back 14. The light-directing element or the diaphragm is preferably secured to the upper or lower side of the first housing part at a position provided for it. Since it is provided that the elements can be replaced as desired it is in particular provided that this interface is standardized.

It may also be provided that a device for holding the lamp 1 is provided on the first housing part 5 and/or the second housing part 4.

It is preferably also provided that a convection-driven, controlled air exchange takes place at least in a section between the upper and lower sides of the lamp 1, which is formed due to the use of elements influencing convection, such as a diaphragm, a grid, diffusing plate of a reflector in the case of low pressure discharge lamps or a heat sink when light-emitting diodes are used as the light sources. In particular it is provided that the light, which contains the lamp, is always attached slightly spaced from the ceiling or wall to ensure precisely this air exchange, whereby high temperature stresses on the lamp and operating device, as normally occur in a downlight, are avoided. The air exchange can in particular be adjusted such that optimum operating conditions are established for the respectively used lamp 1. This can be seen in the case of a low-pressure discharge lamp in that a cold spot temperature in the range between 40° and 50° is adjusted. In the case of a lamp fitted with light-emitting diodes as the light source this controlled air exchange occurs in such a way that the junction temperature describing the luminous efficacy of the LED chip is as low as possible, in particular is <70° C. With a further type of lamp, in which the light source is a halogen light source, this is adjusted such that the pinch temperature relevant to the service life of the lamp is as low as possible, in particular is <350° C.

It may also be provided, moreover, that the front 13 and/or back 14 is designed so as to be at least partially open, so the heat established during operation can flow from the second housing part 4 to the outside. It is preferably also provided that, in addition, the first housing part 5 is also designed so as to be partially open at least at specific points, so heat may also be conveyed from the second housing part 5 here as well. If there is a partition 7 it may optionally also be provided that this partition 7 includes corresponding openings, wherein the first housing part 5 then also includes such openings in particular.

With regard to the production of the through-flow, a fan or blower (not shown) may optionally also be arranged and this is preferably disposed in the region of the first housing part 5 or in the region of a heat sink.

FIG. 2 shows in a further schematic sectional view a further exemplary embodiment of the lamp 1. This is again designed as a discharge lamp and it may be seen that, in contrast to the design according to FIG. 1, the overall height of the first housing part 5 is equal to the overall height of the second housing part 4.

Electronic components 6a, 6b and 6c, by way of example, of the electronic operating device 6 are also illustrated which are arranged on a circuit carrier 15 which is an annular printed circuit board by way of example.

The arrows P1 symbolize the convection flow by way of example which flows through the front 13 and back 14 provided with openings.

FIG. 3 shows a further sectional view of an exemplary embodiment of the lamp according to FIG. 2, wherein a grid 16 is constructed here in the region of the front 13 of the second housing 4. The grid can also be electrically connected to protective ground, which is provided by one of the contacts 9 to 12, and this leads to a reduction in electrosmog.

The grid 16 is preferably designed as a two-part grid, wherein grid lamellae each form part of adjacent grid parts and run between adjacent sections of the discharge vessel 3.

The grid shown in FIG. 3 can also be constructed as an anti-glare element and/or as an element for focusing the light emitted downwards in FIG. 3, so glare is avoided and the light is directed forwards. This is particularly advantageous if the grid 16 has the stated two-part structure.

FIG. 4 shows a further exemplary embodiment of the lamp 1 in a sectional view, wherein the lamp 1 is designed in accordance with the diagram in FIG. 2 or 3, and adjacent to the back 14 includes a light-directing element which may be a reflector 17 by way of example. This can be at least partially reflective, wherein a reflection is also to be understood within the meaning of diffusion here, so a diffusing plate may also be constructed here. The reflector 17 can also be arranged on the opposing side and therefore adjacent to the front 13 of the second housing part 4.

The arrow P1 again indicates the convection through the openings in the back 14 and optionally openings in the first housing part 5, moreover.

In the exemplary embodiments according to FIGS. to 1 to 4, in which the lamp 1 is constructed as a discharge lamp, a cooling of the cold spot to about 40° C. to 55° C. is achieved by way of the air exchange depending on the tube diameter, wherein this regulation of the air exchange takes place over the surface and the temperature gradient between above and below the lamp, which is substantially dependent on the specific area output and the ambient temperature.

Controlled and adjustable convection can be enabled by way of the grid 16 and/or the reflector 17 in conjunction with the openings in the second housing part 4 and/or the first housing part 5.

The reflector 17 and/or the second housing part 4 is/are preferably coated with TiO₂ on the side facing the lamp. Efficient air cleaning can also be enabled by such an embodiment due to the adjustable convection.

It may also be provided that the grid 16 is constructed integrally in the first housing part 5 and/or second housing part 4. In particular it may be provided that the grid forms an injection molded unit with the first housing part 5 and/or the second housing part 4 and is permanently connected thereto. A releasable connection may also be provided, however, so it can be reversibly removed and attached again at any time without being destroyed. The lamp can consequently be redesigned simply and in an easily manageable manner such that it can be designed for bidirectional emission of light or for emission upwards or emission downwards.

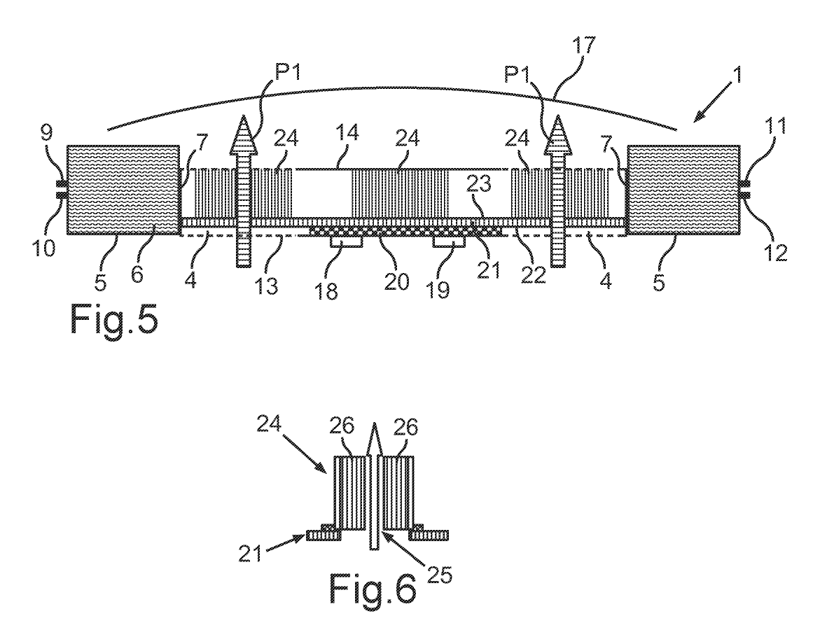

FIG. 5 shows a further simplified sectional view through a further exemplary embodiment of a lamp 1. In contrast to the embodiment of the lamp in FIGS. 1 to 4 there is no discharge lamp formed here and instead the light sources of the lamp 1 are designed as semiconductor components, in particular as light-emitting diodes 18 and 19, in FIG. 5. A design is again shown here in which the first housing part 5 is higher than the second housing part 4.

The light-emitting diodes 18 and 19 shown merely by way of example in number and position are arranged on a plate-like support 20. This is secured to the lower side 22 of a cooling plate 21. Three heat sinks 24 are arranged on an upper side 23 of the cooling plate 21 in the exemplary embodiment and these, like the cooling plate 21, are located in the second housing part 4. The second housing part 4 is again designed with openings on the front 13 and back 14 here, so convection occurs according to the arrow direction P1 here as well. The height of the heat sink can also be greater than shown in FIG. 5, in particular if the light is preferably attached at a spacing from the ceiling or wall.

It may also be provided that the heat sink 24 is part of the light and is configured with respect to cooling capacity so as to be significantly more powerful than heat sinks which are part of the lamp, and therefore are upwardly limited as far as the surface area is concerned to a disk with diameter d2.

The partition 7 between the first housing part 5 and the second housing part 4 may also be present here.

FIG. 5 also shows a design in which an anti-dirt screen is positioned on the side facing the back 14. Like the other light-directing elements, this is preferably secured to the first housing part 5 and is used to capture dirt particles which flow through the lamp via convection. The element can be removed for cleaning, as may reflectors or diffusing plates. In addition, the anti-dirt screen may also assume the function of convection limiting. The support 20 is preferably constructed from aluminum.

The dirt prevention element or the anti-dirt screen may be provided in addition to or instead of the reflector 17 in the design of the lamp 1 according to FIGS. 1 to 4 as well as in the design of the lamp 1 according to FIG. 5, so the regions located behind the lamp 1, such as the ceiling or wall, are not soiled by dust or similar contaminants in this regard. This dirt prevention element may also be present on its own, so a lamp may also be constructed in this regard which includes just this element but no reflector 17.

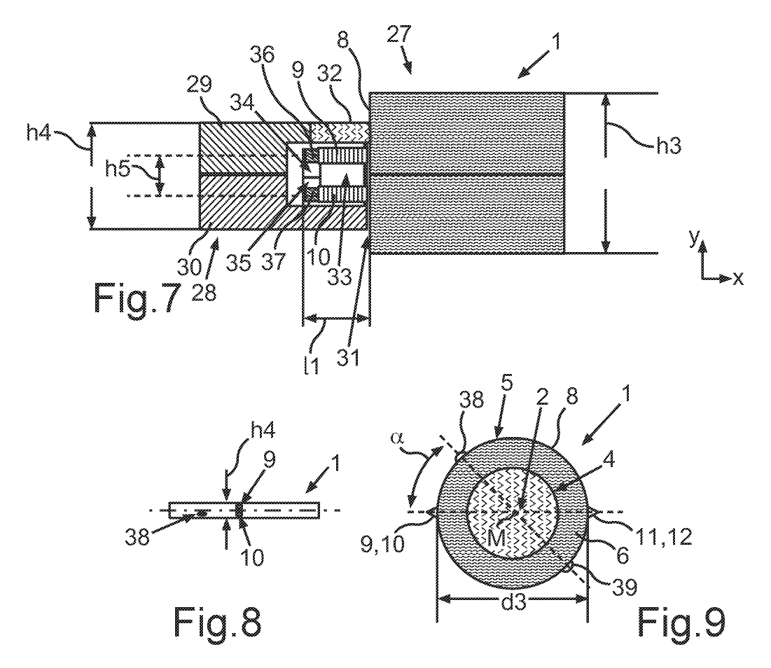

FIG. 6 shows a sectional view through an exemplary embodiment of a heat sink 24. This is designed as a cylinder and includes a central opening. Radially oriented cooling walls 26 are also formed in the inside of the cylinder, wherein the cylinder wall preferably has a much greater material thickness than the radial cooling walls around which air flows. This can be seen in the plan view in FIG. 7.

It may also be provided that the cooling plate 21 is designed as an extruded section. No explicit heat sink 24 is present in particular in this case.

A cover for capturing dirt particles, which are produced owing to a convection-driven air exchange and are guided upwards, is preferably constructed in the lamp according to FIG. 5 and in that according to FIG. 4 and generally in lamps which are provided in accordance with the embodiments in FIGS. 1 to 5 for a convection-driven air exchange, primarily if the light fixing is provided close to the ceiling.

If a reflector 17 is provided, then in a discharge lamp according to the illustration in FIGS. 3 and 4 it is provided that a ratio between the external diameter d1 of a tube of the discharge vessel 3 and a spacing d4=d1+w1 between a spacing determined on one side by two adjacent tube parts of the discharge vessel 3 is between <1.5 and >3.

It is precisely if a reflector 17 is present that it is preferably provided that the discharge vessel 3 has a thicker phosphor layer on its inside on the side facing the reflector 17 than on the side remote from the reflector 17. The ratio of the layer thicknesses between the layer thickness on the side facing the reflector and the side remote from the reflector is preferably <2 and >5. It is precisely if a reflector 17 of this kind should be present in a lamp 1, and this is constructed as a discharge lamp, that an additional reflective layer is applied to the inside of the discharge vessel 3 and this preferably reflects light forwards, and therefore in the direction of the side of the housing remote from the reflector 17, in the spectral range visible to human beings.

FIG. 7 shows in a schematic sectional view a partial detail of a light 27 which includes a lamp 1 in the form of a flat lamp, it being possible by way of example for the lamp 1 to be designed according to one of the designs in FIGS. 1 to 5. The lamp 1 can also be designed as a flat lamp in a different design, with reference being made in this connection to the following descriptions relating to further exemplary embodiments of lamps.

The light 27 includes a plate-like lamp support 28 which includes a recess 29 in the exemplary embodiment in which the lamp 1 can be inserted. It can be seen that the lamp 1 is higher with regard to its overall height (extension in the y direction) than the lamp support 28. In this regard the lamp 1 is designed with a height h3 of 12 mm by way of example. By contrast, the height h4 of the lamp support 28 is 8 mm in the exemplary embodiment. As will be stated and described in more detail below, the lamp support 28 can be a single plate or be composed of two separate plates. In the exemplary embodiment the lamp support 28 is constructed from two separate plates 29 and 30 which are joined together. The two plates 29 and 30 can be connected to each other by way of example by the construction of the light mounting.

The electrical contacts 9 and 10, which are designed as contact springs, arranged directly one above the other in the y direction are shown by way of example. The upper plate 29 includes an indentation 32 into which the contact pins 9 and 10 and a locking element (not shown), which is also constructed on the outside 8 of the lamp 1, can be introduced. The recess 31 in the lamp supports 28 and 29 is designed to completely receive the lamp 1 and in the illustrated exemplary embodiment is a through-hole.

In the exemplary embodiment the extent of the elements for electrical contacting of the base-holder system, including the contacts 9 and 10 and the light-side contact element 35, have a length 11 which is 6 mm by way of example. A respective opposing indentation is produced in the two plates 29 and 30, moreover, so an undercut zone 33 is also formed in this regard into which the contact pins 9 and 10 can be inserted and can be rotated with the lamp 1 and its axis A with regard to attaining and adjusting the final mounting position. The geometry of the undercut zone is to be regarded as a circular ring around the lamp axis A, onto which the recess 31 adjoins on the lamp side. The rotation can be seen in this sense via a longitudinal axis which extends in the y direction.

For this purpose, in the region of the undercut zone 33 said indentations 34 and 35 are constructed in the form of grooves into which the electrical contacts 9 and 10 then extend. In the illustrated embodiment the two electrical cables 36 and 37, which have a rectangular cross-section in the illustrated design, are arranged so as to be integrated in these grooves 34 and 35.

In the illustrated design the two electrical contacts 9 and 10 have a vertical spacing h5 which is 3 mm in the exemplary embodiment.

With regard to the dimensioning, a feeding slot 32 can be designed in relation to its dimensions with a length of 4.5 mm, a width of 1.5 mm and a depth of 3 mm. The undercut zone 33 is implemented with regard to its dimensions preferably with 4 mm in the y direction and with regard to the circumferential extent (x direction) with 4.75 mm. The electrical contacts 9 and 10 can preferably have dimensions such that they are designed with or without spring deflection, wherein without spring deflection a length of 5 mm up to length between 1 mm and 6 mm is advantageous. Without a spring deflection a length of 3.8 mm may be advantageous. The width is preferably 1.2 mm and the depth preferably 1.5 mm. With regard to their cross-sectional dimensions, and therefore their rectangular shaping, the two cables 36 and 37 preferably have a square design with a side length of 1 mm.

The grooves 34 and 35 are preferably designed with a length of 1.25 mm and a width of 1.6 mm. With regard to the length this relates to the extension in the x direction, the width of the extension in the y direction and the depth in the direction of the z axis, which extends perpendicular to the drawing plane, therefore in the direction of the light axis in the case of a linear light.

FIG. 8 shows a schematic side view of a lamp 1.

The arrangement of the contacts 9 and 10 one above the other, viewed in the vertical direction, can be seen. A locking element 38 can be seen, moreover, which is constructed circumferentially spaced from the electrical contacts 9 and 10 on the side wall 8 of the lamp and engages in a corresponding recess in the lamp support 28 to fix the lamp in position in the lamp support 28.

FIG. 9 shows a schematic plan view of a further exemplary embodiment of a lamp 1 which has a disk-shaped design. It may be seen here as well that the electronic operating device 6 is arranged in a first housing part 5 which annularly surrounds the light source 2 and the second housing part 4. The electrical contacts 9 and 10 on the one hand and the electrical contacts 11 and 12 on the other hand are constructed on the circumferential surface or side wall 8 of the first housing part 5 on opposing sides. The projection of the contacts into the lamp plane is therefore arranged on a straight line through the center point M of the lamp 1, wherein the electrical contacts 9 and 10 are positioned vertically one above the other and this applies accordingly to the electrical contacts 11 and 12. Reference is made in this regard to the exemplary illustration in FIG. 7.

The first locking element 38 and a second locking element 39 are constructed on this side wall 8, moreover. Their projection into the lamp plane is also arranged on a straight line through the center point M. In the exemplary embodiment they are also arranged at an angle α, which is 45°, so as to be spaced apart from the respective electrical contacts 9 and 10 and 11 and 12. According to the illustrated design the locking elements 38 and 39 are semi-spherical and preferably have a height between 1 mm and 5 mm, preferably 3 mm.

The lamp 1 can be constructed according to the designs in FIGS. 1 to 5 and in terms of the type of lamp can be a discharge lamp or an LED lamp in this regard. It can, moreover, also be a halogen lamp, by way of example, wherein the light source of the lamp 1 is then a halogen light source in this connection.

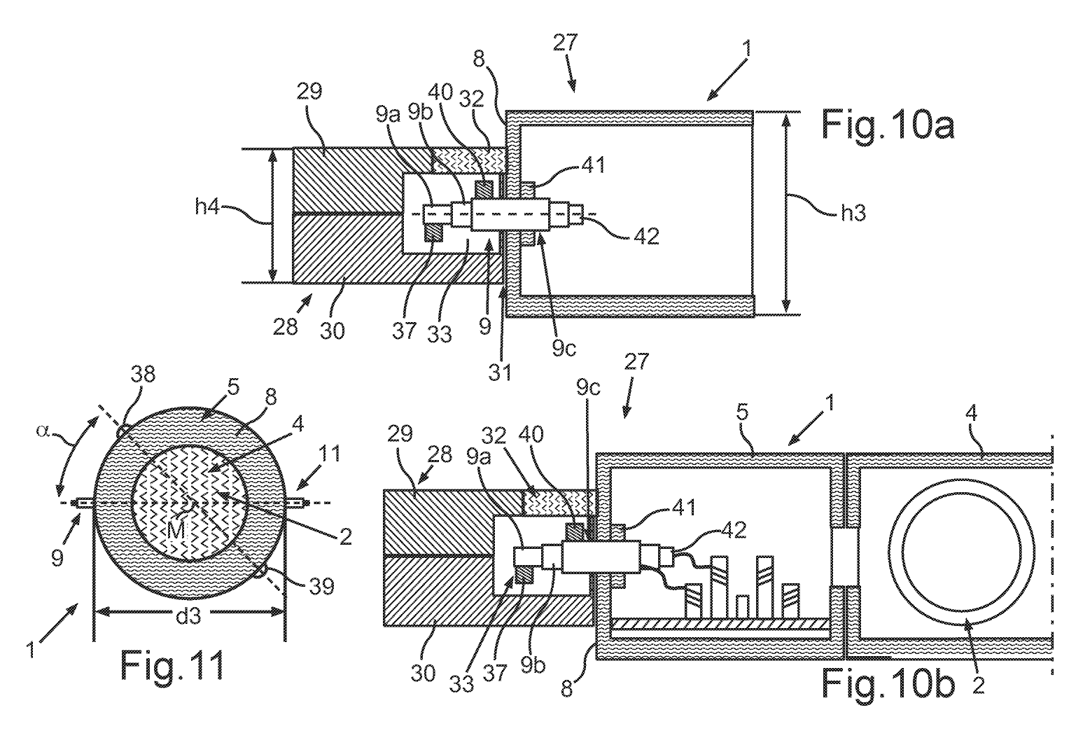

FIG. 10a shows a further exemplary embodiment of a light 27, with only a partial detail of the total light 27 being shown again here. A flat lamp, which with regard to its height h3 is larger than the height h4 of the lamp support, is also introduced here in an analogous design to the illustration in FIG. 8. The lamp support 28 is in turn constructed from two separate plates 29 and 30. A base-holder system is constructed here which is formed by the design of the embodiment of the lamp support 28 and the electrical contacts.

In contrast to the embodiment according to FIG. 7, the electrical cables 36 and 37 in the lamp support 28 are not arranged directly one above the other in the vertical direction in this case and instead are vertically positioned one above the other but are also arranged so as to be mutually offset in the x direction.

This is required in the illustrated exemplary embodiment because on this side the lamp 1 does not include two separate contacts 9 and 10, which come to rest one above the other in the projection plane of the lamp, but just a single contact 9, designed as a contact pin, which is constructed as a twin contact. This means that it has a first contact region 9a which is constructed as an internal pin and protrudes forwards and is contacted by the lower cable 37. This first contact part 9a is circumferentially surrounded by electrical insulation 9b. This electrical insulation 9b is then in turn surrounded by a second contact part 9c which is electrically contacted by a control cable 40 in the exemplary embodiment. Signals for adjusting the brightness and/or coloring of the light emitted by the lamp 1 are transmitted via this control cable 40. For reasons of shock-hazard protection the mains cables are in this case arranged spaced further apart from the lamp axis A, and those which do not carry high voltage, such as signal cables and protective ground, are preferably arranged closer to the recess.

The contact 9 constructed as a twin contact is therefore electrically contacted on the one hand by the mains cable 37 and the control cable 40, with this occurring by way of the two separate, but combined into one contact pin, contact parts 9a, 9c, which are coaxially constructed. A control cable 9c is provided on the operating device-side which is held by a plastic part 41 via which the signals of the light-side signal or control cable 40 are forwarded and there is also a lamp-side mains cable 42 via which the mains signals of the cable 37 are forwarded.

In one example the mains cables are connected to the first twin pin, and protective ground and the signal cable to the second twin pin. When implementing the SELV principle—i.e. when supplying the lamp-side operating device with a direct voltage of <60 V via a second operating device in a third housing part—the first twin pin should preferably carry the DC voltage and the second twin pin should be reserved for two signal cables for “receiving” and “sending” signals.

FIG. 10b shows a further example of a lamp 1, wherein, to supplement the illustration in FIG. 10a, the second housing part 4 is also partially shown and the feedthrough between the first and second housing parts 5 and 4 for cables is shown.

FIG. 11 shows a plan view of a lamp 1 as can be inserted in FIGS. 10a and 10b in the light 27 or lamp support 28 shown therein. One twin contact in the form of the electrical contact 9, which then also includes the contact 10 (not described in greater detail), and a second twin contact in the form of the electrical contact 11, which is also constructed as a contact pin and includes the contact 12 (not described in greater detail) are shown on opposing sides of the side wall 8. With regard to the embodiment of the lamp support 28 in the region of the electrical contact 11, there is a similarity to the illustration in FIG. 11 in this respect. In a manner analogous to the illustration in FIG. 11, the electrical contact 11, constructed as a twin contact, provides the electrical contact 9, with the inner contact part then being electrically connected to the further mains cable 36 in this regard.

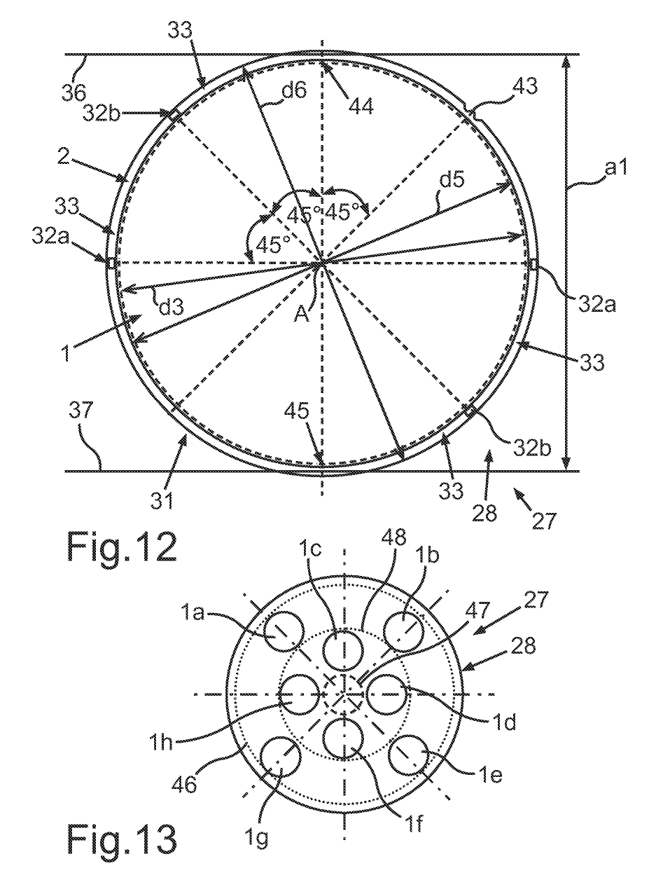

With regard to the mains cables 36 and 37, these are arranged more or less at the bottom in the embodiment according to FIG. 12 of the lamp 1, thereby also forming shock-hazard protection in this regard. No such shock-hazard protection is required with regard to the control cable 40 and the connection to protective ground formed on the opposing side, to which the electrical contact 11 is connected.

With regard to insertion of the lamp 1 into a recess 31 in the lamp support 28, the disk-shaped lamp 1 is firstly inserted in the direction of its longitudinal axis A, which extends in the y direction, and the electrical contacts 9 to 12 and the locking elements 38 and 39 are introduced via appropriately designed feeding slots 32 and, as it were, through the upper plate 29. Following this insertion the lamp 1 preferably rests on the locking elements 38 and 39 on the lower side of the undercut zone 33 and this avoids mechanical stressing of the electrical contacts 9 to 12. The electrical contacts 9 to 12 and the locking elements 38 and 39 are freely rotatable about the longitudinal axis A of the lamp 1 in the undercut zone 33 up to the region of the zone where for each locking element 38 and 39 there is an inwardly-directed molded part, into which the locking elements 38 and 39 latch when a certain application of force is exceeded.

With regard to the embodiment of the light 27, a base-holder system is therefore formed for connection to the lamp 21, with the holder being part of the lamp support 28. All holder elements are incorporated therein, an insert preferably being provided as an injection molded part in this regard which contains all of these mechanical holder elements apart from the power supply lines. A particular property of this base-holder system is that the contacts normally present in a holder do not physically exist and their function is assumed by the preferably square cables 36 and 37, which are laid in the light, and its cables running on the other side of the light 27, which are not identified or illustrated in greater detail.

Electrical contacting of the electrical contacts 9 to 12 by the cables 36, 37, 40 and 41 is preferably solely by way of bending moments, which result with a corresponding design of the dimensions relating to the contact pin diameter and the spacing of the light-side wires and cables and materials. A type of wedging is consequently more or less achieved between the electrical contacts 9 to 12 and between the wires in the lamp support 28.

FIG. 12 shows an example of the light 27 in a simplified plan view.

In this regard the lamp support 28 is shown, wherein, incorporated into the lamp support 28, the cables 36 and 37 are arranged so as to run parallel. A spacing a1 is formed in the exemplary embodiment which is 123.5 mm.

The external diameter d3 of the lamp 1 is also illustrated and this is 120 mm by way of example. Feeding slots 32a and 32b are also shown, with the feeding slot 32a being shown for the electrical contacts 9 and 10 and the opposing contacts 11 and 12 according to the embodiment in FIG. 8. Feeding slot 32b is provided for locking element 38 by contrast, so an angle of 45° is formed between the two elements.

Corresponding feeding slots are also formed on the opposing side respectively, so the opposing electrical contacts 11 and 12 and the opposing locking element 39 can also be introduced accordingly there.

A diameter d5 is also illustrated which gives the internal diameter of the recess 31, and this is 121 mm in the exemplary embodiment. It is therefore only 1 mm larger than the external diameter d3 of the lamp 1.

A diameter d6 is also illustrated which shows the internal diameter of the movement zone in the lamp support 28. This means that in the exemplary embodiment the movement zone therefore extends over the region in which the locking elements 38 and 39 and the electrical contacts 9 and 12 can remain or move, and is defined thereby. The movement region is therefore a hollow cylinder which adjoins the recess 31 and otherwise extends into the interior of the lamp support 28 without advancing as far as its surfaces. This diameter d6 is therefore 5 mm greater than the diameter d5 and 6 mm greater than the external diameter d3 of the lamp 1.

A locking zone 43 is shown, moreover, in which the locking element 38 introduced into the feeding slot 32b or the indentation engages if the lamp in the lamp support 28 is introduced in its end position. This means that, following insertion of the lamp 1 by lowering and therefore moving along the longitudinal axis A of the lamp 1 extending perpendicular to the drawing plane, and therefore the insertion of the locking element 38 into the feeding slot 32b and the electrical contact 9 and/or 10 into the feeding slot 32a and subsequent rotation of the lamp 1 in the clockwise direction about the axis A by 90°, the locking element 38 latches in this locking zone 43. In this position of the final mounting position the electrical contact 9 and/or 10 has then attained the contacting position 44 in which it electrically contacts the cable 36 and therefore rests thereon more or less perpendicularly in this regard. In particular it is provided that the locking zone 43 is designed to be open at the top and bottom. In the engaged end position a locking element 38 can consequently be snapped out of the locking zone 43 at the top and bottom if the lamp 1 is rotated about an axis of rotation lying in the drawing plane and which runs through the center point and the electrical contacts of the lamp 1, or is tilted relative to the lamp support 28. The lamp can then be tilted out of the drawing plane.

The same applies to the electrical contacts 11 and/or 12 and locking element 38, with a corresponding locking zone (not shown) being formed on the opposing side of the locking zone 43 in this regard and a contact point 45 being formed opposite contact point 44 with regard to the contacting of the cable 37.

FIG. 13 shows a further plan view of an exemplary embodiment of a light 27, the light 27 being circular in this regard. It again includes a lamp support 28 composed of two plates 29 and 30, with a plurality of circular disk-shaped flat lamps in the form of lamps 1a, 1b, 1c, 1d, 1e, 1f, 1g and 1h being constructed in this lamp support 28. The number and arrangement of lamps 1a to 1h is purely an example. All lamps 1a to 1h are designed as flat lamps. At least one of the lamps 1a to 1h can be constructed with a light-emitting diode as the light source. At least one lamp 1a to 1h can be constructed with a halogen light source, moreover. It may also be provided that at least one lamp 1a to 1h is constructed as a discharge lamp. The light 27 can therefore include at least two different types of lamp and be equipped accordingly.

It can be seen that the lamps 1a, 1b, 1e and 1g are arranged in an outer circular ring so as to be equidistant from each other in the circumferential direction, and the lamps 1c, 1d, 1f and 1h are similarly arranged equidistant from each other in an inner circular ring. The lamps 1a, 1b, 1e and 1g are each arranged at an offset of 45° to an adjacent lamp in the inner segment of a circle.

Cables are circularly laid in the lamp support 28, with two cables 46 and 47 being of a first polarity and a cable 48 having a second polarity. Each lamp 1a to 1h is therefore contacted by two cables 46 to 48 of different polarity.

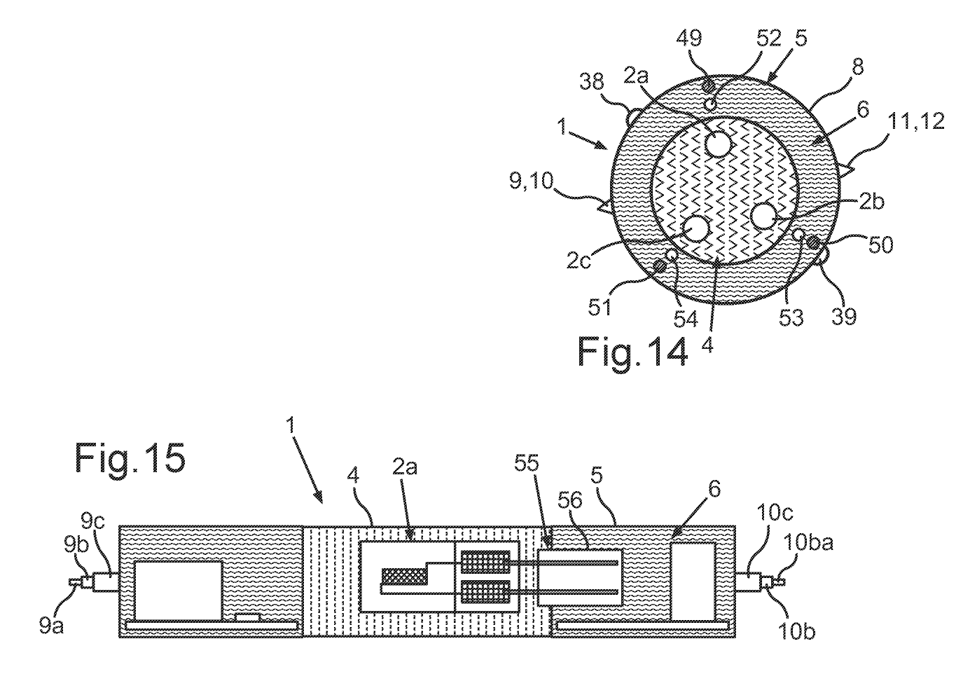

FIG. 14 shows in a schematic plan view a further exemplary embodiment of a lamp 1. This is equipped with three light sources 2a, 2b and 2c by way of example. The light sources 2a to 2c are designed as halogen light sources, so the lamp 1 is a halogen lamp. In the exemplary embodiment the light sources 2a to 2c are detachably arranged and can therefore be easily removed and re-inserted. Holders are constructed in the second housing part 4 for this purpose.

It is also provided that each light source 2a to 2c includes a separate optical display element 49, 50 and 51, the display elements 49 to 51 being light sources, in particular light-emitting diode lamps. The optical display elements 49 to 51 display a disruption in function or operation of the associated light source 2a to 2c.

As may be seen from the illustration in FIG. 14, these display elements 49 to 51 are arranged on a corresponding circuit carrier in the first housing part 5. They are preferably arranged on the circuit carrier on which the electronic components of the operating device 6 are also arranged. Reset buttons 52, 53 and 54 for fuses are also arranged adjacent to the optical display elements 49 to 51.

The light sources 2a to 2c are preferably connected in series.

The operating voltage of the lamp is 230 V. The light sources 2a to 2c are preferably configured as 77 V light sources and connected in series. It may also be provided that the light sources are configured with a nominal operating voltage of 12 V and that the operating device is designed without a transformer. In this case the lamp 1 is supplied with a SELV voltage of 60 V and five halogen light sources with a nominal voltage of 12 V are connected in series.

The light sources 2a to 2c are also preferably designed as pin-base lamps, by way of example with a G9 base. They also preferably have an IR-reflective coating. In the inner region of the module the housing parts 4 and/or 5 are made at least partially from a temperature-stable material, by way of example LCP or PPS. Receivers, by way of example for fixing a reflector or reflectors, can preferably also be provided in this region. A reflector is preferably adjustable in the direction of the lamp axis, which extends perpendicular to the drawing plane, enabling adjustment and optimization of the aspect ratios. This adjustment preferably occurs by way of a screw thread on the end of the reflector.

As already mentioned, the reset buttons 52 to 54 for the fuses are integrated in the operating device 6. Lamps with solid holding elements without a lamp-side fuse can also be used as a result. The lamp fuses are preferably electronic and can be reset by these buttons 52 to 54 so it is not necessary to replace a fuse when a lamp fails.

The display elements 49 to 51 are preferably LED light sources which only react if mains voltage is applied to a light source 2a to 2c. Symmetrization of the power consumption with a series connection of the light sources 2a to 2c may also be provided.

FIG. 15 shows in a schematic sectional view an exemplary embodiment of a lamp according to FIG. 14 which is designed as a halogen lamp. In this embodiment it is provided that the light source 2a extends in the lamp plane and does not protrude upwards or downwards beyond the overall height therefore. In a preferred form the lamp has an integrated reflector, as is sold by way of example by the Applicant under the name Ministar. The lamp can be contacted by the mains cable via the contact 9a, 9b, 9c, designed as a twin contact, analogously to FIG. 10a. However, it may also be provided that it is only supplied with a low voltage of 60 V.

It is also provided that a second contact 10a, 10b, 10c, which is also designed as a pin-like twin contact, is contacted by protective ground and a control cable, which carries 230 V, or by two control cables which carry 60 V direct current. It may be provided in particular in the case of a low-volt design that the electronic operating device part is divided into two operating device parts and only one operating device part is arranged integrated in the lamp 1 with associated corresponding electronic components and the other operating device part is arranged externally to and spaced apart from the lamp.

A base 56 for the light source 2a is also provided which is secured by a fixing 55.

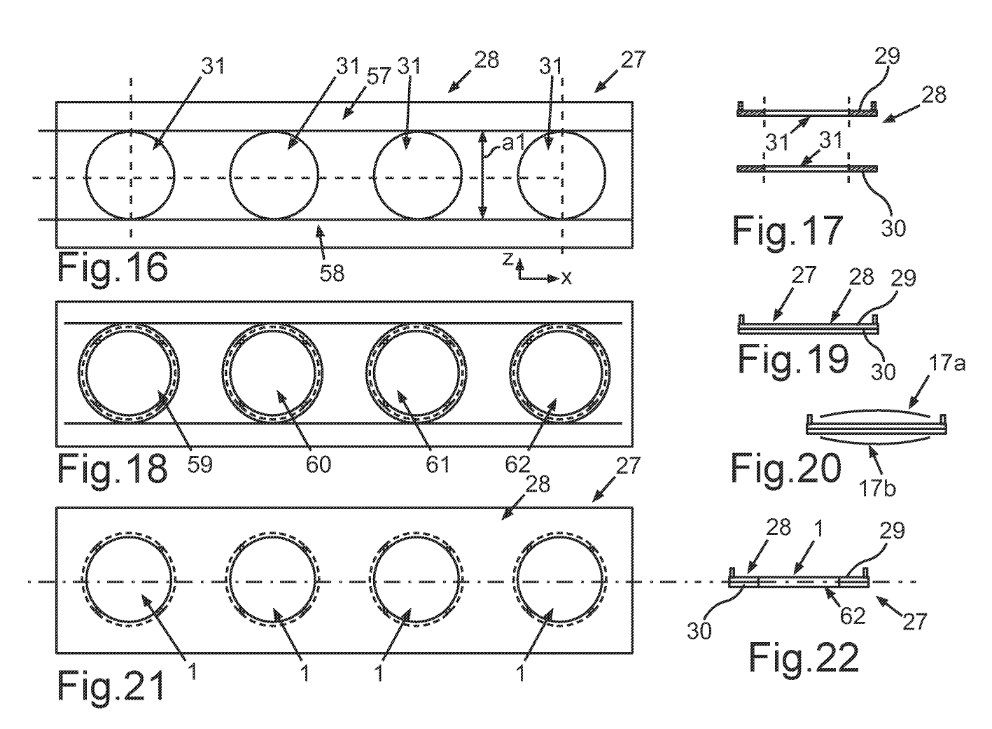

FIG. 16 shows in a schematic plan view part of a lamp support 28, a side view of the lamp support 28 with the upper plate 29 and the lower plate 30 being shown in accordance with the adjacent illustration in FIG. 17. A plurality of recesses 31 is formed in both plates into which flat lamps with circular geometry can then be introduced. In the exemplary embodiment the two plates 29 and 30 are designed with identical dimensions and are formed from plastic, in particular acrylic glass. In the x direction in the exemplary embodiment the two plates 29 and 30 have a length of 800 mm and a width in the z direction of 200 mm. The recesses 31 are constructed with regard to their detailed design in accordance with the illustration in FIG. 12. In particular they have a diameter d6 of 126 mm in the exemplary embodiment according to FIG. 12.

According to a first embodiment, to produce a light 27 firstly the two plates 29 and 30 are provided and the recesses 31 introduced as holes, or the plates 29 and 30 are already cast with the holes. According to the schematic illustration grooves or trenches or indentations 57 and 58 are formed on the opposing sides of the recesses 31, moreover, into which the cables 36 and 37, arranged on opposing sides with respect to a recess 31 in the present exemplary embodiment, and/or the cable 40 are introduced.

According to a first exemplary embodiment in the plan view in FIG. 18 pot-shaped lamp holders 59, 60, 61 and 62 are then introduced which are then designed for receiving the corresponding lamp 1. The lamp holders 59 to 62 include the feedings slots, undercut zones, grooves, locking zones and contact positions, already mentioned previously in relation to FIGS. 7 to 12, in an integrated manner. This is schematically shown in the illustration in FIG. 18.

In a further method step the upper plate 29 is then connected to the lower plate 30 according to the side view in FIG. 19.

It is preferably provided in this regard that a mechanical coupling connection, such as a clip, a snap connection or even a connection similar to a dovetail, is present in this regard. Corresponding connecting elements can preferably be provided on the lamp holders 59 to 62 in this regard.

In the further lateral schematic view according to FIG. 20 it may also be provided that light-directing or light-shaping elements, such as one or more reflector(s), one or more diffusing plate(s) or even a grid or a diaphragm 17a and 17b limiting convection are formed on the upper side and/or lower side. The elements 17a and 17b can be attached and mounted in different production phases of the light 27 or even not until with the customer.

In FIG. 21 one lamp 1 respectively is then inserted in one of the lamp holders 59 to 62 following the production stage according to FIGS. 18 and 19. Insertion occurs analogously to the explanation in FIG. 12 in this regard, so the lamps 1 are brought into their mounting position in their lamp holders 59 to 62, and are locked there, by insertion and rotation. The locking elements and electrical contacts are each finally arranged at their corresponding locking zones and contact points.

The light 27 can be designed to receive a plurality of lamps 1 of the same lamp type, but also to receive lamps of different types. With regard to the embodiment, the lamps 1 can be designed in accordance with the specific types already described several times above.

FIG. 22 shows a schematic sectional view in which the definitively assembled light 27 is shown. The suspensions (not identified in more detail) projecting upwards on the sides are also shown and these are preferably fixed to the end pieces (not described) of the upper plate of the lamp support.

It is preferably provided that equipping with reflectors 17a and 17b and/or with grids and/or with diaphragms and/or with further cooling elements is carried out following the production stage, as has been attained in FIG. 21. The elements limiting convection and/or anti-dirt elements and/or optionally further glare-reducing elements can then also be mounted and attached in this regard. This variability allows the customer to individually design his light and to adapt it to changed lighting tasks, which result for example as a consequence of a move.

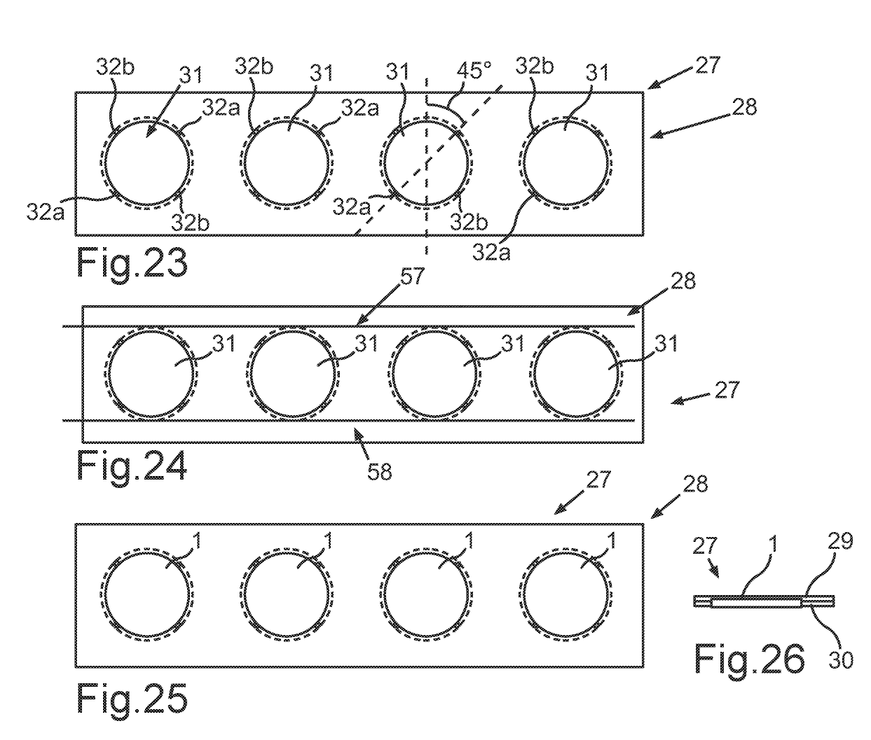

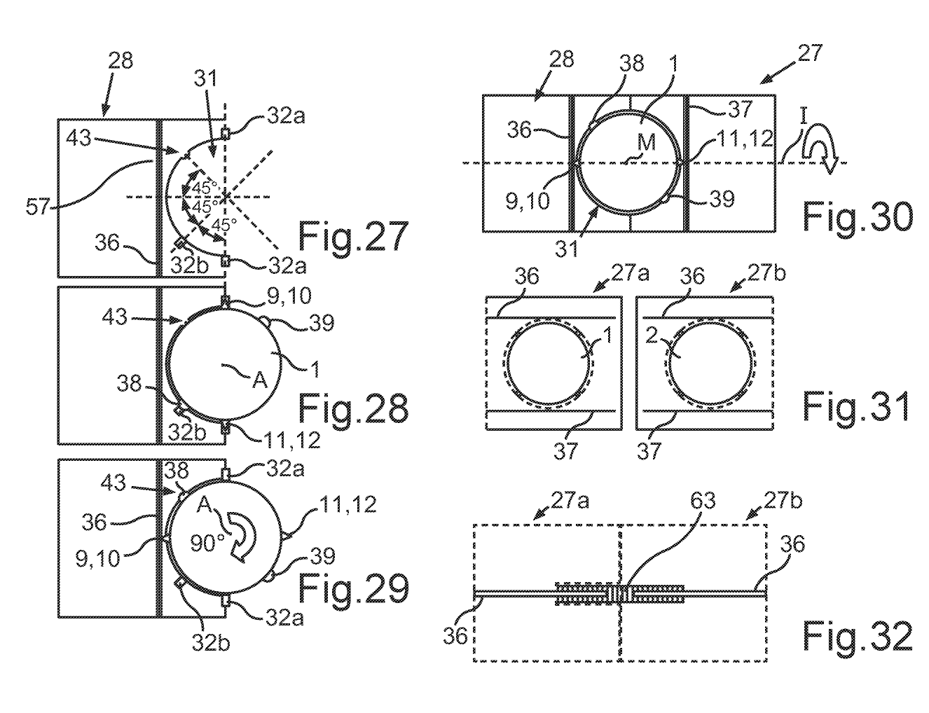

FIG. 23 shows a further plan view of a lamp support 28 of a light 27, wherein, in contrast to the embodiment in FIGS. 17 to 23, a variant of a production method of the light 27 is illustrated in this regard. Two plates 29 and 30 (FIG. 27) are also provided here by way of example. The plates are dimensioned and provided accordingly and recesses 31 are again introduced into the two plates 29 and 30 which, according to FIG. 12, have a diameter of d5=221 mm. In a next method step the circular undercut zones having a diameter of d6=126 mm and a depth of 2.4 mm are worked into the inside of the plates 29 and 30. Indentations are then produced on the edge of these recesses 31 and constitute the feeding slots 32a and 32b for the electrical contacts 9 to 12 on the one hand and for the locking elements 38 and 39 on the other hand. As can already be seen in the illustrations in FIGS. 7 and 11 as well as FIG. 8, these are only introduced to a depth such that they extend only up to the undercut zones 33 introduced on the other side of the plate.

According to the plan view in FIG. 24 the indentations or grooves 57 and 58 are then produced and the corresponding cables are then introduced into them. In a further step the two plates 29 and 30 are then connected, it being possible to provide a glued joint, a screwed connection, a clip connection, a snap connection or a different bolt connection or the like.

According to the further production stage the lamp 1 is then inserted in the recesses 31 in the plan view according to FIG. 25. This takes place directly and without the formation of lamp holders 59 to 62, as has been carried out in the exemplary embodiment according to FIGS. 16 to 22.

The further statements relating to the process of introducing the lamp 1 and the option of attaching reflectors and other additional elements and components are analogous to the explanation of the mode of production in the light 27 according to FIGS. 16 to 22, and reference is made with regard to the embodiment of the production according to FIGS. 23 to 26 to the explanations made in this regard. FIG. 26 shows a schematic sectional view of the assembly stage or production stage of the light 27, as has been attained in FIG. 25.

FIGS. 27 to 29 show plan views of components of a light 27 in different method stages of production. Insertion of the lamp is illustrated again here, as has already been presented by way of example in relation to FIG. 12. Starting from the illustration in FIG. 27, in which the lamp support 28 is completely assembled for insertion of a lamp 1, the lamp 1 is inserted perpendicular to the drawing plane, and therefore along its longitudinal axis A, according to the view in FIG. 28, wherein this takes place in such a way that the electrical contacts 9, 10 or—if there is only one twin contact according to a contact 9—this is/are inserted into the feeding slot 32b, wherein at the opposing side the contacts 11, 12—or if there is only one contact 11, this is/are inserted into the opposing feeding slot 32a. At the same time the locking element 38 is inserted into the feeding slot 32b and the locking element 39 is constructed on the opposing feeding slot 32b (not shown). The feeding slots 32a and 32b constitute indentations on the edge of the recess 31.

Once introduction has been achieved in this regard according to the illustration in FIG. 28, a rotation about 90° is carried out in the clockwise direction about the axis A according to the view in FIG. 30, so the locking element 38 then engages in the locking zone 43, wherein the optionally opposing locking element 39 engages in a corresponding locking zone. The electrical contacts 9 and 10 and 11 and 12 contact the provided cables 36 and 37, moreover, as well as ground potential and a control cable 40, as has already been described.

FIG. 30 shows a plan view of a light 27 in which a lamp 1 is arranged in the lamp support 28 in the completely assembled end state and therefore in the final mounting position. An axis of rotation I is shown which runs through the center point M of the lamp 1 and also runs through the contacts 9 to 12, moreover.

The light 27 is arranged so as to rotate about this axis of rotation I and can be pivoted accordingly, wherein the contacts are designed as twin contacts and as contact pins for this purpose.

It may also be provided that the lamp 1 can be rotated about this axis of rotation I relative to the lamp support 28. In this case the contacts are arranged as twin pins, which are located in the axis of rotation.

FIG. 31 shows in a plan view a first lighting module or a first light 27a and a second lighting module or a second light 27b which each include at least one lamp 1. The lights 27a and 27b are constructed in accordance with the embodiments already illustrated or in part features can be constructed accordingly.

FIG. 31 shows the two lights 27a and 27b separately. They can be retentively joined together, and this is shown in FIG. 32, resulting in a lighting system. A schematic sectional view is shown there, wherein this is shown in the region of a cable 36. A connecting sleeve 63 is formed in this picture according to FIG. 32 and this contacts the two mains cables 36 of the individual modules 27a and 27b and electrically connects them together. The same is formed in the case of the two cables 37 and the cable for grounding and signal transmission. The lamp supports 28 can also be retentively connected together by plug-in connections or snap connections or the like.

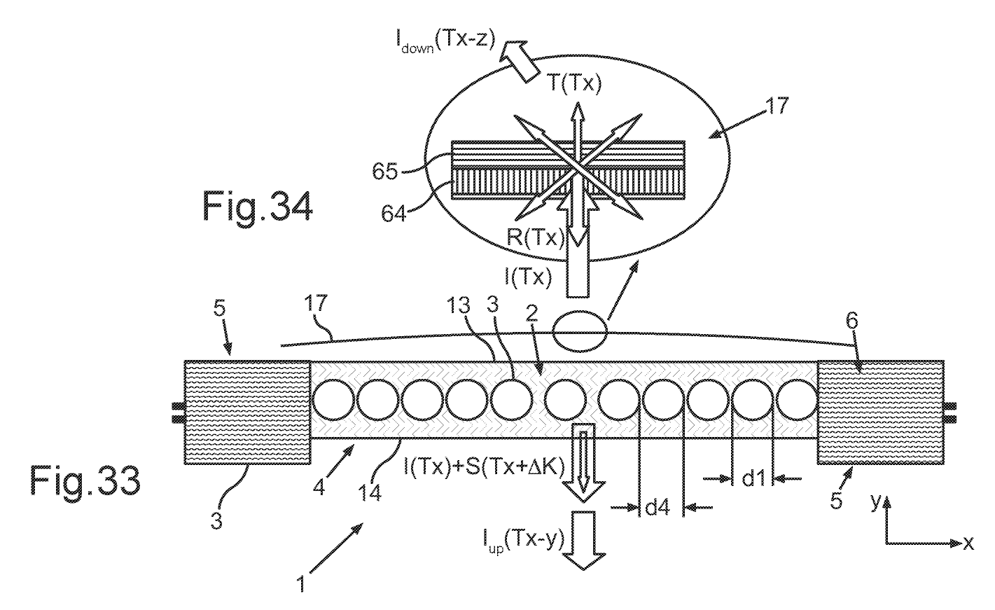

FIG. 33 shows the lamp 1 according to the illustration in FIG. 1, wherein a reflector 17 is also arranged on the front of the second housing part 4 facing the front-side 13 so as to be spaced apart therefrom.

The reflector 17 is designed such that the light from the light source 2, which is the only light source, allows the emission to be distributed among the upper and lower half spaces, it being possible to freely adjust this proportional emission.

Luminous fluxes in the two emission directions existing upwards and downwards, and therefore in the positive and negative y directions, can be freely adjusted in a range between 0% and 100% of the lamp luminous flux.

The reflector 17 is also designed for diffusing the light, for reflecting the light for photocatalysis and for color conversion of the light emitted by the light source 2 and for limiting convection and as a dirt trap. The possibility of a color shift in preferably one of the two emission directions is enabled by way of the reflector 17. This is expedient by way of example in applications where a (white) ceiling is to be illuminated by a light color similar to daylight and the (darker) floor is to appear in a warmer light color. This produces advantages in the lighting of high spaces with suspended lights without the requirement of a suspended ceiling having to be used. The glare effect is reduced by the possibility of additional light diffusion and the light density of the light source is evened out. Efficient air cleaning due to photocatalytic reactions of the coating of the reflector 17 in connection with UVA radiation from the lamp 1 is also achieved.

In the exemplary embodiment the reflector 17 according to the enlarged illustration in FIG. 34 (partial detail of the reflector 17) includes a support 64 which is made from plastic. It is preferably provided that the support 64 is constructed from two different plastics that are transparent to light, by way of example PC and PMMA, which have different refractive indices. This results in an intensification of the intrinsic diffusing effect.

The support 64 is coated with an at least partially reflective layer 65. The support 64 has a transmittance T and a diffusing effect S. Color-converting phosphor particles can be added to the support material, and this leads to a color conversion, and therefore to a temperature shift predominantly of the light emitted in the negative y direction in the image. The at least partially reflective layer 65 has a reflectance R. The reflector 17 is constructed as an at least partially mirror-coated reflector 17 with a reflection factor R. As shown in the exemplary embodiment the layer 65 is applied to the side of the reflector 17 remote from the light source 2 and therefore the lamp 1 as well. A reflection therefore occurs only after transmission of the light through the support 64.

The light is either almost completely reflected or almost completely transmitted depending on the size of the reflectance R and transmittance T. A degradation of the reflector 17 into a cover disk can be achieved in this regard.

As the reflector 17 or the light-directing element is designed as a convection limiter, lamps 1, as have been described previously, can also be used in very cold environments, such as cold stores.

The reflective layer 65 can also be designed as a non-metallic reflective layer made from an inorganic material which is highly reflective in the visible spectral range and which in this case is applied as a layer to the side of the support 64 facing the light source 2. The layer 65 preferably includes TiO₂ as an addition, which, in conjunction with UVA radiation, allows photocatalytic decomposition reactions of organic vapors which lead to the formation of CO₂, water and hydrates. Air cleaning can be achieved as a result. The photocatalytic reaction is enabled without the production of negative ions. Owing to convection in at least partially open housing parts 4 and/or 5, the air comes into contact with the material TiO₂. The coating with TiO₂ is formed in particular on the side of the support 64 facing the light source 2.

Diffusing bodies, which are at least in part phosphor, are preferably added to the material of the plate-like support 64. A kind of phosphor is preferably introduced which leads to the conversion of blue light into long-wave light, for example in the green-red spectral range, with a temperature shift of the light emitted in the negative y direction. The phosphor is preferably a YAG:Ce type, in particular the phosphor L 175.

The grain structure of the phosphor is preferably in the range of greater than one micrometer and less than 50 micrometers.

It may be provided that the phosphor is applied as an additional layer to the side of the reflector 17 facing the light source 2. It may also be that the phosphor is preferably introduced in the granules of the plastic of the plate-like support 64.

In particular it is provided that the discharge vessel 3 is coated on the inside with a phosphor layer, with the layer thickness varying. In particular it is provided that this phosphor layer is thicker on the side facing the reflector 17 than on the side remote from the reflector 17.

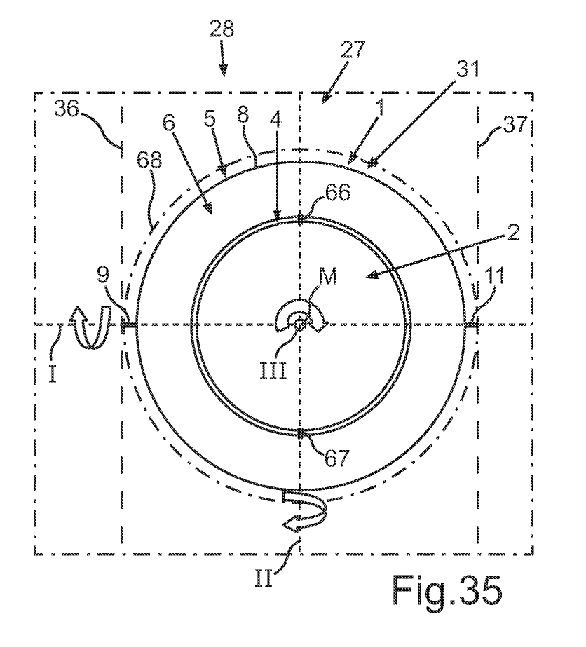

FIG. 35 shows a schematic plan view of a light 27. The light 27 is constructed in accordance with the embodiments relating to the previous figures, wherein it includes the plate-like lamp support 28 and at least one lamp 1, which is arranged in a recess 31, in this regard. The lamp 1, constructed as a flat lamp, is designed as a flat cylinder according to the plan view and is therefore more or less disk-like. In particular it is provided that the lamp 1 includes two opposing electrical contact pins 9 and 11 which lie on a straight line through the center point M of the lamp 1. The contact pins 9 and 11 are designed as twin contacts, as have already been illustrated above. The lamp 1 can be rotated about these contact pins 9 and 11 and a first axis of rotation I relative to the lamp support 28. It is also provided that the lamp 1 is constructed such that the second housing part 4 with the light source 2 is constructed separately from the second housing part 5 with the electronic operating device 6. Further electrical contact pins 66 and 67 are constructed on opposing sides of the second housing part 4 in this regard, wherein these contact pins 66 and 67 also lie on a straight line through the center point M and are constructed in particular as twin contacts. This straight line runs perpendicularly to the straight line through the contact pins 9 and 11. In the exemplary embodiment it is provided that the second housing part 4 of the light source 2 can therefore be rotated about a second axis of rotation II, which runs perpendicular to the first axis of rotation I. The second housing part 4 can therefore be rotated about this second axis of rotation II relative to the first housing part in this regard.

It is also provided that a third axis of rotation III is provided, which runs perpendicular to the drawing plane and perpendicular to the first and second axes of rotation I and II. Lamp 1 can also be rotated about this third axis of rotation III relative to the lamp support 28. It may be provided in this regard that the entire lamp 1 can be rotated about this third axis of rotation III relative to the lamp support 28. However, it may also be provided that the lamp 1 is constructed in such a way that the second housing part 4 can be rotated about this third axis of rotation III relative to the first housing part 5 of the lamp 1. Rotation about the third axis of rotation III is ensured if the contacts 9 and 11 and/or contacts 66 and 67 are sliding contacts.

In addition to said cables 36 and 37 these broken lines may also include the protective ground and the control cable 40. The undercut zones are also indicated here by way of example by the reference numeral 68.

The electrical contacts 66 and 67 can likewise be constructed as twin contacts, with the contact assignment being typical for the lamp in this case. In the case of discharge lamps, for example the electrode 1 is connected to the contact pair 66 and electrode 2 to contact pair 67.

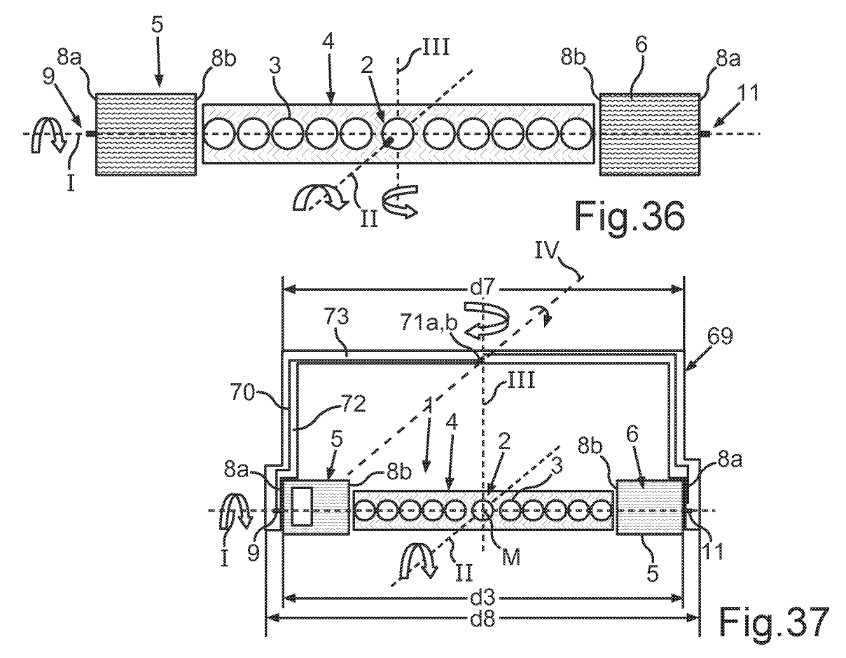

FIG. 36 shows a sectional view of the lamp 1 according to FIG. 35, wherein it has been removed from the lamp support 28 of the light 27 to simplify the illustration in this regard. In the illustrated exemplary embodiment the lamp 1 is a discharge lamp. The first housing part 5 includes a side wall 8 with an external outer side 8a and an internal outer side 8b.

FIG. 37 shows a further exemplary embodiment in which the lamp 1 is arranged in an adapter 69 and can be rotated about the axis of rotation I relative to the adapter 69 if the contacts 9 and 11 are two contact pins respectively. Integrated in the adapter 69 are electrical cables 70 between the electrical contacts 9 to 12, designed as contact pins, and an electrical contact 71a and 71b constructed in the adapter 69 as a twin pin. These establish the electrical contact with the light or its holder. The adapter 69 includes struts 72 and an extension adapter 73.

The adapter 69 has a diameter d7, wherein the adapter 69 surrounds the housing 5 so as to encompass it and is widened in this regard and has a diameter d8.

The cables for electrical connection are therefore preferably integrated in the adapter 69. In particular, the cables for electrical connection of the contact pins between the electronic operating device 6 and the lamp 1 are also integrated in the operating device 6.

The extension arms of the adapter 69 are constructed as struts 72.

It may also be provided that the adapter 69 can be rotated about an axis IV and/or the axis III relative to a lamp support 28 on which the adapter 69 can be arranged. In the case of rotation about the axis III the contacts 71a and 71b are designed as sliding contacts.

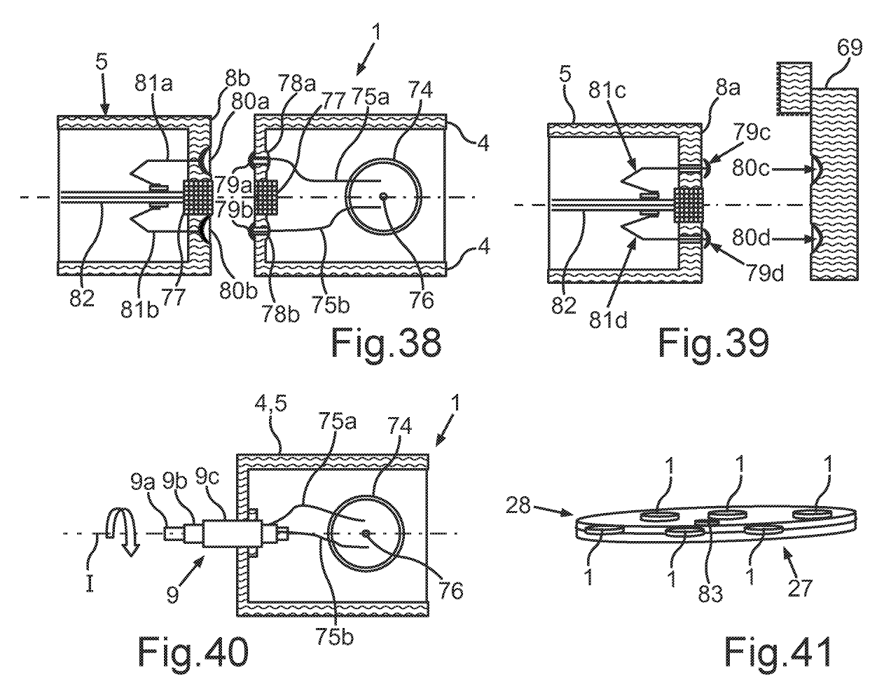

If according to one exemplary embodiment the contacts 9 to 12 are contact pins and the lamp 1 is constructed such that the housing part 5 can be rotated relative to the housing part 4, in particular about the axis II, electrical contacts can be constructed between the housing part 5 and adapter 69 as sliding contacts. Reference is made in this regard to the explanations which follow relating to FIG. 38.

In a further design of the lamp 1 it can be provided that the contacts 9 and 11 are not contact pins but sliding contacts. This produces a variant in relation to the direction of rotation. The lamp 1 then cannot be rotated relative to the adapter 69 about the axis I but about the axis of rotation III. Assuming that with this design the sliding contacts are arranged on the external outer side 8a of the housing of the lamp 1, it can, moreover, be provided, if the lamp includes two housing parts 4 and 5 which can be moved relative to each other, that the electrical contacts between the two housing parts 4 and 5 are contact pins in particular. As a result the housing parts 4 and 5 can be rotated relative to each other about the axis of rotation I or II. In relation to the sliding contacts between the adapter 69 and the housing of the lamp 1, reference is made to the following explanations relating to FIG. 39.

Preferably at least two, and a maximum of four, such struts 72 are constructed. The contact system between the lamp 1 or the light source 2 and the housing part 5, which includes at least components of the operating device 6, is preferably constructed so as to be codable. This coding can be implemented by way of example by different dimensioning of the length and/or diameter of the electrical contacts. It can thereby be ensured that only lamps which are electrically compatible with the operating device 6 are connected thereto.

In particular the rotation about the axes of rotation I to III is carried out via a motor drive which can be activated by a remote control. The adapter 69 also allows the lamp diameter to be adjusted. By way of example the lamp 1 can have the same, a larger or a smaller diameter as/than a corresponding lamp without an adapter 69.

FIG. 38 shows a schematic sectional view through a lamp 1, which in this case is a discharge lamp, in the region of a seal. The lamp seal 74 is shown which in this case is designed as a stem tube seal. Reference characters 75a and 75b illustrate the power supply lines. An exhaust tube 76 is also formed.

The entire housing of the lamp 1 is again constructed in two parts and includes a connecting region 77.

Protrusions 78a and 78b with passages for power supply line contacting are also shown. A metallic coating electrically conductively connected to the power supply lines 75a and 75b is also formed on the partial circumference of the housing, wherein four segments in particular are provided in this regard and electrical contacts 79a and 79b are constructed as sliding contacts on the side wall of the second housing part 4. The relative rotation between the housing parts 4 and 5 about the axis III according to FIG. 37 is given as a result.

The connecting regions 77 are mechanically constructed and are provided for mechanically connecting the two housing halves of the housing parts 4 and 5.

Furthermore, contact elements 80a and 80b, constructed as sliding contacts, of the operating device 6 are constructed with integrated spring contacts 81a and 81b on the internal outer side 8b in the first housing part 5. The circuit carrier 82 is also shown. In the contacted state contacts 79a and 79b engage in the contact elements 80a and 80b.

FIG. 39 shows a sectional view of a section between the adapter 69 and the first housing part 5. Electrical contacts 79c and 79d are also constructed here as sliding contacts on the external outer side 8a and these make contact with contact elements 80c and 80d constructed as sliding counter-contacts and allow the rotation of the housing part 5 relative to the adapter 69 about the axis III, which is also the longitudinal axis A of the lamp 1. Integrated spring contacts 81c and 81d are also constructed here, moreover.

Rotation of the lamp 1 about the axis III is in particular possible if the mains and control cables are arranged in the lamps support 28 circularly around the lamp 1, as is indicated by way of example in FIG. 36 by the cables 68.

The operating device- or adapter-side contacts preferably have a convex surface with a specific radius. The electrically conductive connections on the circumference of the adapter 69 are preferably designed in an angular range of ±85° around the axis of rotation III, so a range of rotation of 170° results.

The first housing part 5 preferably has concave counterparts, corresponding to the adapter-side convex protrusions, having a similarly specified radius which is smaller than the radius of the convex adapter-side contacts. The ratio between the radius of the convex surface of the adapter-side contact to the concave counterpart on the sides of the first housing part 5 is preferably in an interval greater than 1.01 and smaller than 1.2 in this regard. A safe electrical and mechanical connection can be created as a result. The lamp 1 is preferably inserted in the adapter 69 by pushing-in from below, wherein the convex protrusions on the operating device-side engage in the concave cavities of the adapter 69 and can then rotate.

FIG. 40 shows an embodiment of a lamp 1 which in a lamp housing 4, 5 includes the light source with a lamp seal 74 and an exhaust tube 76. The power supply lines 75a and 75b are connected to a contact 9 constructed as a twin contact. Reference is made in this regard to the statements relating in particular to FIG. 10 with respect to the contact parts 9a and 9c and the insulation 9b.

FIG. 41 shows in a schematic perspective illustration a light 27 which includes a disk-shaped lamp support 28 in which a plurality of lamps, which are constructed as disk-shaped flat lamps, is arranged.

In the illustrated design the lamps 1 are all of different types, so a low-pressure discharge lamp with integrated ballast, an LED lamp and a halogen lamp as well as an OLED lamp are formed in this regard. An electronic driver 83 is also integrated in the lamp support 28 in this regard and this functions as a driver for the OLED lamp.

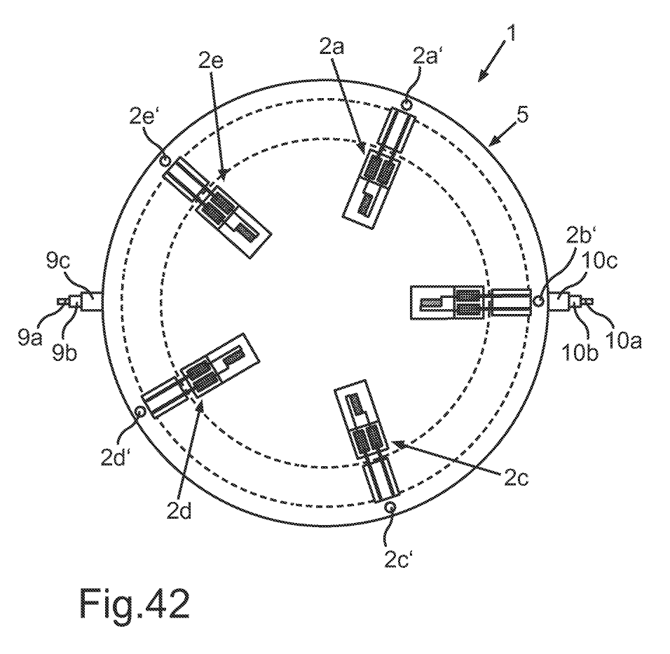

FIG. 42 shows a further exemplary embodiment of a lamp 1 in a plan view. In this embodiment the disk-shaped lamp 1 includes five light sources 2a to 2e which are constructed as halogen light sources. The light sources 2a to 2e are arranged in particular such that they extend in the plane of the lamp 1 and therefore in the plane of the drawing. The light sources are designed with a nominal operating voltage of 12 V. They are connected in series and supplied with a low voltage of 60 V, so an SELV conceptual design is formed. Contact pins are constructed on the outside of the first housing part 5 and are implemented as twin contacts 9a, 9b, 9c and 10a, 10b, 10c. The twin contacts are located on a straight line through the center point of the lamp 1, so it is also possible to rotate the lamp about this straight line. A light-emitting diode 2a′ to 2e′ is also arranged adjacent to each light source 2a to 2e, via which a function display of the associated light source 2a to 2e occurs. The electronic components of the light-emitting diodes 2a′ to 2e′ in particular are arranged in the first housing part 5. Further components can preferably be arranged as a second operating device part in a third housing which is secured by way of example to a ceiling at a spacing form the first housing part 5. Signal cables, which carry low voltage, can be laid between the first housing part 5 and the third housing and can simultaneously be used as the suspension cables of the lamp 1. It may also be provided that the lamp 1 is constructed without components of the electronic operating device and the operating device is arranged completely externally to the lamp 1.

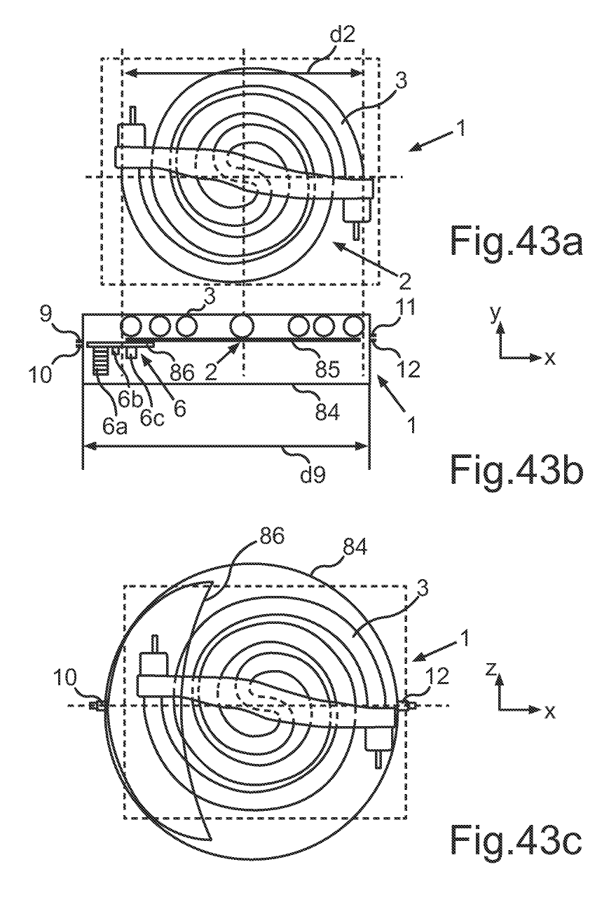

FIGS. 43a to 43c show a further exemplary embodiment of a lamp 1 which is constructed as a flat lamp. In the exemplary embodiment it is constructed as a flat cylinder, wherein a housing 84 in particular has this kind of form. A flat cylinder is larger in its width dimensions (x direction and z direction) and therefore also in its diameter, and in particular larger by a multiple, than in its height extension (y direction). The lamp 1 is a discharge lamp and constructed analogously to the basic designs in FIGS. 1 to 4. There the operating device 6 is constructed radially laterally in the circumferential direction around the light source 2 at least in an annular section.

In the designs in FIGS. 43a to 43c this is, by contrast, constructed in such a way that the operating device 6 extends with its electronic components 6a to 6c only in certain sections below the light source 2 and laterally thereto. As can be seen in the side view in FIG. 43b, this means that components 6a to 6c extend in the y direction and therefore in the vertical direction below the light source 2 and extend laterally in the x direction and therefore the horizontal direction over the horizontal extent of the light source 2 as well.

Horizontally arranged between the light source 2, which includes the spirally wound discharge vessel 3 extending in one plane, is a partition 85 which is transparent to light. The lamp 1 does not include two housing parts 4 and 5 either, but just one housing part 84 on whose outer side electrical contacts 9 to 12 are arranged. Advantageous embodiments relating by way of example to the design of contacts, reflector elements, etc., disclosed in FIG. 5ff, also apply to the design according to FIGS. 43a to 43c.

As shown in FIG. 43a, the width d2 is only 101 mm here. A total width d9 of the disk-shaped or discus-like housing 84 is 120 mm in the embodiment.

As may also be seen in FIG. 43c, the operating device 6 is sickle-shaped. This means that the components 6a to 6c are arranged on a correspondingly design printed circuit board 86. FIG. 43c also shows the electrical wiring in the region of the discharge vessel 3 between the two end regions of the vessel 3 and the electrical contacts 9 to 12.

1. A lamp, comprising,
at least one light source; and an electronic operating device;
wherein at least some electronic components of the operating device are arranged laterally with respect to the light source.

2. The lamp as claimed in claim 1,
wherein the operating device and the light source are arranged in a common housing.

3. The lamp as claimed in claim 1,
wherein at least some electronic components of the operating device are arranged radially laterally with respect to the light source in a first housing part constructed circumferentially at least in certain regions around the light source.

4. The lamp as claimed in claim 3,
wherein the light source and the electronic components are arranged in one plane.

5. The lamp as claimed in claim 1,
wherein at least some electronic components of the operating device are arranged laterally with respect to the light source and only in certain regions below the light source so as to overlap the light source.

6. The lamp as claimed in claim 5,
wherein the electronic components are arranged in a sickle shape.

7. The lamp as claimed in claim 1,
wherein a partition is arranged between the electronic components and the light source.

8. The lamp as claimed in claim 1,
wherein the lamp comprises at least two electrical contacts.

9. The lamp as claimed in claim 1,
wherein it is a discharge lamp and the light source comprises a discharge vessel filled with a gas, which is designed so as to be multiply wound.

10. The lamp as claimed in claim 1,
wherein at least one second housing part, in which the at least one light source is arranged, is constructed so as to be open on at least one of the upper side and the lower side for the through-flow of air.

11. The lamp as claimed in claim 3,
wherein the first housing part is constructed so as to be open on at least one of the upper side and the lower side and the side wall for the through-flow of air.

12. The lamp as claimed in claim 1,
wherein an element limiting convection is provided and is constructed as at least one of the following group consisting of:
a grid; and/or
a reflector; and
a diffusing plate to avoid glare.

13. The lamp as claimed in claim 1,
wherein a light source is a semiconductor element.

14. The lamp as claimed in claim 1,
wherein a light source is reversibly detachably arranged in the lamp.

15. The lamp as claimed in claim 1,
wherein a light source is a halogen light source.

16. The lamp as claimed in claim 1,
wherein a plurality of halogen light sources is provided which are connected in series.

17. The lamp as claimed in claim 1,
wherein the light source can be rotated relative to the operating device.

18. The lamp as claimed in claim 3,
wherein the electronic components in the circumferential direction of the light source are arranged in the first housing part in at least one annular section around this light source.

19. The lamp as claimed in claim 8,
wherein the lamp comprises at least three electrical contacts.

20. The lamp as claimed in claim 13,
wherein the semiconductor element is a light-emitting diode.
